(19) United States
(12) Patent Application Publication
(10) Pub. No.: US 2016/0153407 A1
(43) Pub. Date: Jun. 2, 2016

(54) AIR INTAKE HEATER SYSTEM AND METHODS

(71) Applicant: HIDRIA AET, Tolmin (SI)

(72) Inventors: Peter Ursic, Kobarid (SI); Janez Urbas, Tolmin (SI); Dean Kravos, Vipava (SI)

(73) Assignee: HIDRIA AET, Tolmin (SI)

(21) Appl. No.: 14/902,414

(22) PCT Filed: Jul. 3, 2014
(86) PCT No.: PCT/EP2014/064193

§ 371 Date: Dec. 31, 2015

Related U.S. Application Data
(60) Provisional application No. 61/842,488, filed on Jul. 3, 2013.
(60) Provisional application No. 61/904,306, filed on Nov. 14, 2013.

(51) Int. Cl. F02M 31/04; F02M 35/10

(52) U.S. Cl. CPC F02M 31/042; F02M 35/10268

(57) ABSTRACT

An air heater for heating intake air for an internal combustion engine is provided. The air heater may have a heating element with improved air flow redirection. The air heater may include a controller that is formed as an integral component with an other component of an internal combustion engine such as an air intake manifold cover. The heater may include thermocouple circuitry for sensing the temperature of the heating element. Methods of calibrating the thermocouple circuitry are also provided. Methods of controlling the air heater while performing engine start are also provided.

### FIELD OF THE INVENTION

This invention generally relates to intake heaters for heating intake air for an internal combustion engine.

### BACKGROUND OF THE INVENTION

Many internal combustion engine systems utilize an air intake heater system to heat the intake air prior to combustion of the intake air with fuel depending on the intake air temperature and the operating conditions of the internal combustion engines:

As internal combustion engine systems become more and more complex, the pathway through which the intake air flows to the cylinders of the internal combustion engine system becomes more complex. Typically, the heating element of prior air intake heater systems did not redirect the flow of air as it traveled through the heating element. Due to the complex air flows and constraints within engine compartments, the location of air heaters may not be optimal such that straight through flow of air may be undesirable.

Electrically powered air intake heater systems are operably coupled to a source of power and the current to the heating element is controlled by a controller that includes a relay for operably turning on power or cutting power to the heating element. These electric heaters typically draw a large current. The controller of the air intake heater system will thus control large currents and can generate a large amount of heat. Further, these controllers are often in close proximity to electrical joints which introduce resistance into the electrical circuit which provide for additional heat release. Removal or reduction of this heat from the controller is important to prevent thermal inefficiencies as well as to eliminate potential damage to the controller.

It is desirous to reduce the number of components and cost for these air intake heater systems. Many internal combustion engines have various components manufactured by different companies and then they are subsequently assembled. As such, it is desirous to simplify the assembly of the overall internal combustion engine system.

These air intake heater systems are often mounted to internal combustion engines for vehicles such as automobiles, tractors or other mechanisms that are exposed to or otherwise generate a significant amount of vibrations. As such, it is desirous to reduce effects that these vibrations may have on mounting any of the individual components to the internal combustion engine or securing the individual components of the air intake heater systems together.

These air intake heater systems are required to be preheated before starting the engine so as to allow for preheating of the initial intake air that is used for engine start. When the engine starts to crank, the air intake heater system is turned off in order to have enough battery power for the starter motor to crank the engine. As such, the heating ribbon of the air intake heater system is typically designed to be relative large in order to keep enough thermal energy in the heating ribbon when heated to approximately 900 degrees Celsius such that the accumulated heat can be transferred to air passing through the air intake heater system and into the cylinders during engine start.

This has three problems. First, preheating the air intake heater system, in some instances, can take as long as 20 seconds. However, when people get into a vehicle or machine, they do not want to wait to start the device. Instead, the operator wants to start the engine as soon as possible. Second, the larger amount of material needed for the heating element to accumulate heat for engine start increases the cost of the air intake heater system. However, when the engine is running, there is less need for thermal accumulation because there is not the electrical load on the electrical system of the vehicle, such as operating the starter motor during engine start, which prevents the air intake heater system from operating at higher power. Thus, the heating ribbon is oversized for that which is necessary for the normal operation of the air intake heater system just to accommodate the engine startup issues. The third problem is associated with long preheating times. When a long preheating time is used, a significant part of energy (estimated to be greater than 30%) in some instances is lost to heat transfer from the heating ribbon to adjacent components of the engine such as to the air intake housing or intake manifold, and then, from there, to the air within the engine compartment surrounding the engine and the air intake system.

As such, it is desirous to reduce the amount of time necessary required to preheat the air intake heater system prior to engine start as well as to minimize the size of the heating ribbon.

### BRIEF SUMMARY OF THE INVENTION

In one embodiment, an air intake heater is provided that provides improved air flow directing capabilities such as air flow redirection. The air intake heater includes a heating element. The heating element includes a plurality of longitudinally extending sections. Each longitudinally extending section has an inlet end and an outlet end and defines a guide face extending between the inlet end and the outlet end. The guide face generally faces, at least in part, upstream such that the air flow impinges upon the guide face. The combination of inlet ends of the plurality of longitudinally extending sections generally defines an inlet face. The combination of the outlet ends of the plurality of longitudinally extending sections generally defines an outlet face. At least the outlet end of the guide face of each of the longitudinally extending sections extends at a non-perpendicular and/or non-parallel angle to the inlet and outlet faces.

In one embodiment, the heating element further includes a plurality of curved connection portions. Each connection portion connecting an adjacent pair of the longitudinally extending sections.

In one embodiment, each curved connection portion defines a trough bottom extending between a top end of the connection portion adjacent the inlet face and a bottom end of the connection portion adjacent the outlet face. The trough bottom being non-perpendicularly angled relative to the inlet and outlet faces.

In a more particular embodiment, the air heater includes a first insulator and a second insulator. The heating element is mounted between the first and second insulators with the longitudinally extending sections extending between first and second insulators with each curved connection portion being supported by or inserted into one of the first or second insulators.

In an even more particular embodiment, the first and second insulators define generally rectangular receiving cavities for receiving the curved connection portions. The receiving cavities being rotated at an angle relative to the inlet and outlet faces such that four of the sides of the rectangular cavities extend at non-parallel and non-perpendicular angles relative to the inlet and outlet faces.

In one embodiment, the rectangular receiving cavities include top and bottom sides. The top side adjacent the inlet ends of the longitudinally extending sections and the bottom side adjacent the outlet ends of the longitudinally extending sections. The top sides being parallel to one another but offset such that they are not aligned and the bottom sides being parallel to one another but offset such that they are not aligned.

In one embodiment, the longitudinally extending sections and connection portions are formed from a single continuous ribbon of material.

In one embodiment, each curved connection portion defines a trough bottom extending between a top end of the connection portion and a bottom end of the connection portion. The trough bottom extending perpendicularly relative to the inlet and outlet faces.

In one embodiment, the curved connection portions include a pair of twisted sections that transition into the corresponding longitudinally extending sections.

In one embodiment, the heating element includes a first insulator and a second insulator. The heating element is mounted between the first and second insulators with the longitudinally extending sections extending between first and second insulators with each curved connection portion supported by or received into one of the first or second insulators. The first and second insulators define generally rectangular receiving cavities for receiving the curved connection portions. The receiving cavities being oriented relative to the inlet and outlet faces such that two of the sides of the rectangular cavities extend perpendicular to the inlet and outlet faces and two of the sides of the rectangular cavities extend parallel to the inlet and outlet faces.

In one embodiment, an air intake heater including an undulating heating element is provided. The undulating heating element includes a plurality of longitudinally extending sections connected by curved connection portions. Each longitudinally extending section has an inlet end and an outlet end and defines a guide face extending between the inlet end and the outlet end. Each curved section has an inlet end and an outlet end and a trough bottom extending between the inlet and outlet ends. The inlet ends of the plurality of longitudinally extending sections generally defining an inlet face and the outlet ends of the plurality of longitudinally extending sections generally defining an outlet face. The trough bottoms extend at a non-perpendicular and non-parallel angle relative to the inlet and outlet faces. Preferably, the angle is between about 45 and 90 degrees such that any air flow redirect is between about 0 and 15 degrees.

In another embodiment, an air heater including a heating element is provided. The heating element includes a plurality of longitudinally extending sections. Each longitudinally extending section has an inlet end and an outlet end and defines a guide face extending between the inlet end and the outlet end. The inlet ends of the plurality of longitudinally extending sections generally define an inlet face and the outlet ends of the plurality of longitudinally extending sections generally define an outlet face. The guide face of each of the longitudinally extending sections is curved between the inlet and outlet ends.

In one embodiment, the heating clement further includes a plurality of curved connection portions. Each connection portion connecting an adjacent pair of the longitudinally extending sections. In a more particular embodiment, the longitudinally extending sections and connection portions are formed from a single continuous ribbon of material.

In one embodiment, each curved connection portion defines a trough bottom extending between a top end of the connection portion and a bottom end of the connection portion. The trough bottom extending perpendicularly relative to the inlet and outlet faces.

In one embodiment, a method of forming an intake heater is provided. The method includes bending a ribbon of heating element material into a plurality of longitudinally extending sections, which are typically parallel, connected by curved connection portions. The longitudinally extending sections have an inlet end and an outlet end and a guide face extending between the inlet and outlet faces. The inlet ends of the plurality of longitudinally extending sections generally define an inlet face and the outlet ends of the plurality of longitudinally extending sections generally define an outlet face. The method further including deforming the bent ribbon of heating element material such that the guide face of each of the longitudinally extending sections extends at a non-perpendicular angle to the inlet and outlet faces, at least at the outlet end of the guide face.

In a more particular embodiment, the step of deforming occurs after the step of bending.

In one embodiment, each curved connection portion defines a trough bottom extending between a top end of the connection portion and a bottom end of the connection portion. The step of deforming includes bending the ribbon of heating material such that the trough bottom of each curved connection portion is non-perpendicularly and non-parallel angled relative to the inlet and outlet faces.

In one embodiment, the method further includes mounting the ribbon of heating material between a pair of insulators with the curved connection portions positioned within rectangular cavities. The rectangular cavities being rotated at an angle relative to the inlet and outlet faces such that four of the sides of the rectangular cavities extend at non-parallel and non-perpendicular angles relative to the inlet and outlet faces.

In one embodiment, each curved connection portion defines a trough bottom extending between a top end of the connection portion and a bottom end of the connection portion. The step of deforming includes bending the ribbon of heating material such that the trough bottom of each curved connection portion remains perpendicular relative to the inlet and outlet faces. Such a method may result in only bending the longitudinally extending sections during the step of deforming.

In one embodiment, an air heater assembly including an internal combustion engine component, which may be an air intake component, and an air heater is provided.

The air intake component guides intake air into an engine including an inlet and an outlet. The air intake component defines a substantially planar mounting surface. The air heater is mounted to the intake component. The air heater includes a heating element including a plurality of longitudinally extending sections. Each longitudinally extending section has an inlet end and an outlet end and defines a guide face extending between the inlet end and the outlet end. The guide face of each of the longitudinally extending sections extends at a non-perpendicular angle relative to the planar mounting surface.

In one embodiment, the guide face is planar between the inlet and outlet ends.

In one embodiment, each of the longitudinally extending sections are spaced a different offset distance from the mounting surface. In this embodiment, the entire air heater may be angled relative to the mounting surface.

In one embodiment, the inlet ends of the plurality of longitudinally extending sections generally defining an inlet face and the outlet ends of the plurality of longitudinally extending sections generally defining an outlet face. The inlet and outlet faces may extend at a non-parallel and non-perpendicular angle to the mounting surface.

In one embodiment, an air intake heater system is provided. The system includes an engine component of an internal combustion engine defining at least part of an intake air flow path. The system includes an air heater operably mounted to the engine component in fluid communication with the portion of the intake air flow path defined by the engine component. An electronic control arrangement is electrically coupled to the air heater for controlling the air heater. The electronic control arrangement is permanently coupled to the engine component.

In one embodiment, the engine component defines a cavity in which a plurality of electronic components of the electronic control arrangement are permanently secured.

In one embodiment, the plurality of electronic components of the electronic control arrangement are permanently secured within the cavity of the engine component with a thermal glue.

In one embodiment, the engine component defines a housing for the electronic components of the electronic control arrangement from which the electronic components cannot be removed.

In one embodiment, the engine component has a generally rectangular outer periphery and a portion of the engine component that defines the housing for the electronic components extends out of the rectangular outer periphery to expose an underside of the housing to the ambient air surrounding the engine component when mounted to an engine.

In one embodiment, the engine component is an air intake manifold cover.

In one embodiment, a control arrangement for an air heater having a heating element for an internal combustion engine is provided. The control arrangement includes an electronic controller configured for switching on and off power to the air heater. An output electrical contact that defines a through hole for receipt of a connector to secure an electrical lead of the air heater to the electronic controller is also provided.

In one embodiment, the electronic controller is a solid state relay.

In one embodiment, the output electrical contact defines an abutment surface on an axial end surrounding the hole. In one embodiment, the connector is a bolt that extends through the hole. A nut is mounted to the bolt and abuts the abutment surface of the output electrical contact.

In one embodiment, the electronic controller and output electrical contact are permanently secured to the housing.

In one embodiment, a control arrangement for an air heater having a heating element for an internal combustion engine is provided. The control arrangement includes an electronic controller configured for switching on and off power to the air heater and an output electrical contact that includes a threaded stud shaft to secure an electrical lead of the air heater to the electronic controller.

In one embodiment, the electronic controller is a solid state relay.

In one embodiment, the electronic controller includes a housing defining a bottom mounting surface. The stud shaft extending axially outward beyond the mounting surface.

In one embodiment, the output electrical contact includes an enlarged head portion attached to the stud shaft. The housing defines a top surface opposite the bottom mounting surface. The housing defines a through hole extending through the bottom mounting surface and the top surface. The enlarged head portion being larger than the through hole.

In one embodiment, the electronic controller and output electrical contact are permanently secured to the housing.

In another embodiment, an air heater arrangement for an internal combustion engine is provided. The arrangement includes an engine component, an air heater, a controller, a thermocouple circuit and a voltmeter. The air heater has a heating element adapted to heat intake air for the internal combustion engine passing therethrough. The heating element is operably electrically coupled to the engine component. The engine component and heating element are formed from different electrically conductive materials. The controller is configured to control a supply of power to the air heater. The thermocouple circuit has a first lead coupled to the heating element at a first electrical junction and a second lead connected to the engine component at a second electrical junction. A voltmeter is configured to sense the voltage difference between the first and second electrical junctions.

In one embodiment, a thermal junction is formed directly between the engine component and the heating element such that they directly touch one another.

In another embodiment, an intermediate segment is interposed between the heating element and the engine component such that at least two thermal junctions are formed between the first and second electrical junctions. The intermediate segment is formed of a different material than the heating element.

In another embodiment, the controller is configured to control the supply of power to the air heater based on the sensed voltage difference.

In one embodiment, a method of controlling an air heater arrangement for an internal combustion engine is provided. The heater arrangement includes an air heater having a heating element adapted to heat intake air for the internal combustion engine passing therethrough. The heating element is operably electrically coupled to the engine component. The engine component and heating element are formed from different electrically conductive materials The controller is configured to selectively control a supply of power to the air heater. A thermocouple circuit has a first lead coupled to the heating element at a first electrical junction and a second lead connected to the engine component at a second electrical junction. A voltmeter is configured to sense the voltage difference between the first and second electrical junctions. The method includes measuring a voltage difference between the first and second electrical junctions and modifying the power supplied to the heating element, by the controller, based on the measured voltage difference.

In one method, a thermal junction is formed directly between the engine component and the heating element.

In another method, an intermediate segment is interposed between the heating element and the engine component such that at least two thermal junctions are formed between the first and second electrical junctions. The intermediate segment is formed of a different material than the heating element.

In one embodiment of the invention, a method of operating an air heater system during engine start of an engine is provided. The method allows for reduced preheat time and/or smaller heating elements as less heat accumulation is necessary in the heating element while the starter motor cranks the engine. The air heater system has an air heater having a heating element and a controller for controlling the supply of power to the heating element. The engine has a starter motor connected to a battery. The method includes activating the air heater to heat the heating element for a predetermined amount of time prior to activating the starter motor; reducing the supply of power to the air heater after the predetermined amount of time has elapsed; activating the starter motor after the step of reducing the supply of power to the air heater; and activating the air heater a second time to heat the heating element after a second amount of time while the starting motor remains activated.

In one method, the second amount of time is a predetermined amount of time.

In one method, the method further includes monitoring the voltage of the battery and the second time ends when the voltage is above a predetermined value.

In one method, the step of activating the air heater a second time does not occur until after the engine has passed top dead center at least one time.

In one method, the step of activating the supply of power to the heating element of the air heater reduces the supply of power to the heating element such that the current draw by the heating element is substantially zero.

In one method, the step of activating the air heater a second time includes supplying less than full power to the heating element.

In one method, the step of activating the air heater a second time includes supplying between about 10% and 50% of maximum power to the air heater heating element. In a more preferred method, the step of activating the air heater a second time includes supplying between about 20% and 40% of maximum power to the air heater heating clement.

In one method, the step of activating the air heater a second time includes supplying less than full power to the heating element by supplying power using pulse-width-modulation. In such a method, the pulses of power could be a maximum power with the average power supplied to the heating element being less than maximum power.

In another embodiment, a method of operating an air heater system during engine start of an engine is provided. The air heater system has an air heater having a heating element and a controller. The engine having a starter motor connected to a battery.

The method includes activating the air heater to heat the heating element for a predetermined amount of time prior to activating the starter motor; reducing the supply of power to the air heater after the predetermined amount of time has elapsed; activating the starter motor after the step of reducing the supply of power to the air heater; monitoring the voltage of the battery; and activating the air heater a second time to heat the heating element when the voltage of the battery is above a predetermined value while the starting motor remains activated.

In one method, the step of reducing the supply of power to the heating element of the air heater reduces the supply of power to the heating element such that the current draw by the heating element is substantially zero.

In one method, the step of activating the air heater a second time includes supplying less than full power to the heating element.

In one method, the step of activating the air heater a second time includes supplying between about 10% and 50% of maximum power to the air heater heating element. In a more preferred method, the step of activating the air heater a second time includes supplying between about 20% and 40% of maximum power to the air heater heating element.

In one method, the step of activating the air heater a second time includes supplying less than full power to the heating element by supplying power using pulse-width-modulation.

In another method, a method of operating an air heater system of an engine while starting the engine is provided. The air heater system has an air heater that has a heating element and a controller for controlling power of the heating element. The engine has a starter motor connected to a battery. The method includes activating the air heater at a first power level to heat the heating element until a desired air heater temperature is reached; reducing the supply of power to a lower value and maintaining the desired air heater temperature; activating the starter motor while monitoring the battery voltage; and activating the air heater a second time to heat the heating element with lower power during engine cranking.

In one method, the method includes turning off power to the air heater proximate the beginning of the step of activating the starter motor.

In one method, the step of turning of power to the air heater occurs when a predetermined voltage drop of the battery is detected.

In one method, the step of activating the air heater a second time occurs at a second power level of approximately between 10 and 50 percent of the first power level.

In one method, the step of activating the air heater a second time occurs when the battery voltage is over a detailed value is detected.

In one method, the step of activating the air heater a second time is stopped if a battery voltage chops below a threshold value

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a schematic illustration of an engine system according to an embodiment of the invention;

FIG. 2 is a simplified illustration of a heating arrangement according to an embodiment of the invention incorporated into an air intake manifold cover;

FIG. 3 is an enlarged illustration of the heater of FIG. 2;

FIG. 4 is a bottom side illustration of the heater of FIG. 3;

FIG. 5 is the air intake manifold cover of FIG. 2 with the heater system removed;

FIG. 6 is a partial illustration of the controller of the heater system of FIG. 2 removed from the air intake manifold cover;

FIG. 7 further illustration of the controller of FIG. 6;

FIG. 8 is an alternative embodiment of a controller according to an embodiment of the present invention;

FIG. 9 is an exploded illustration of a heater component according to an embodiment of the present invention;

FIG. 10 is an embodiment of a heating element according to an embodiment of the present invention;

FIG. 11 is a simplified cross-sectional illustration of the heating element of FIG. 10;

FIG. 12 is further embodiment of a heating element according to an embodiment of the present invention;

FIG. 13 is a cross-sectional illustration of the heating element of FIG. 12;

FIGS. 14A-14C illustrate further concepts relating to heating elements;

FIGS. 15 and 16 illustrate an embodiment of a ceramic insulator for supporting the heating element of FIG. 14;

FIGS. 17 and 18 illustrate a further embodiment of the present invention illustrating a plurality of heater components mounted at an angle relative to a mounting surface of an engine component;

FIGS. 19-21 illustrate an alternative embodiment of a controller;

FIGS. 22 and 23 illustrate thermocouple circuit arrangements for use in accordance with embodiments of the present invention;

FIG. 24 is a simplified schematic illustration of a further thermocouple circuit arrangement::

FIG. 25 is a graph illustrating calibration measurements for calibrating a thermocouple arrangement of FIGS. 22-24;

FIG. 26 is a perspective illustration of a further embodiment of an engine embodiment having a controller and air heater mounted thereto;

FIG. 27 is a bottom perspective illustration of the embodiment of FIG. 26;

FIGS. 28 and 29 are illustrations of a portion of the heating element of the embodiment of FIGS. 26 and 27;

FIG. 30 is an exploded top illustration of the embodiment of FIG. 26;

FIG. 31 illustrates a control strategy for controlling the supply of power or current to the heating element of an air heater during engine start;

FIGS. 32-34 are simplified representative graphical representations of current supplied to the heating element, the current supplied to the starter motor and provided by the battery during an engine start according to the control strategy of FIG. 31;

FIG. 35 illustrates a second control strategy for controlling the supply of power or current to the heating element of an air heater during engine start;

FIGS. 36-38 are simplified representative graphical representations of current supplied to the heating element, the current supplied to the starter motor and voltage of the battery during an engine start according to the control strategy of FIG. 35; and

FIGS. 39-41 are simplified representative graphical representations of current supplied to the heating element, the current supplied to the starter motor and voltage of the battery during an engine start where the battery voltage drops below a predetermined threshold.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

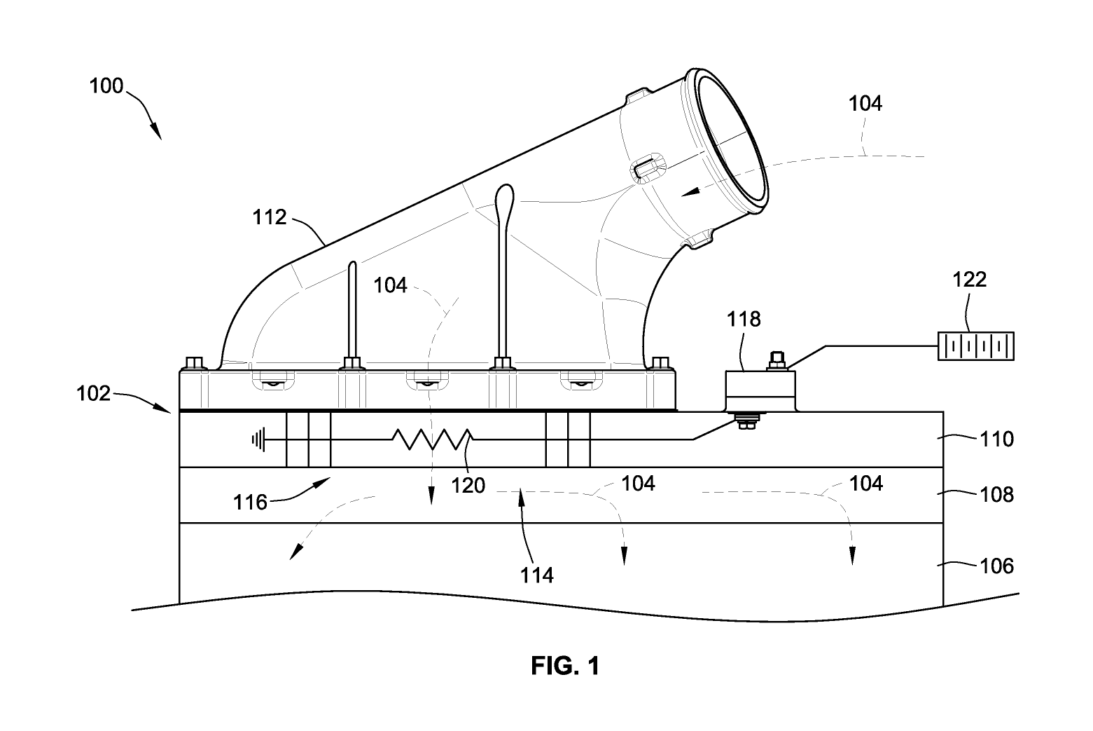

FIG. 1 is a schematic representation of an engine system 100 in accord with an embodiment of the present invention. The engine system 100 generally includes an air intake system 102 for supplying air to be combusted when combined with fuel. The air intake system 102 draws air from an air supply such as the ambient air supply. Air flow through the air intake system 102 is represented by arrows 104.

Illustrated in simplified form, the engine system 100 includes a plurality of internal combustion engine components. For instance, the engine system 100 includes an engine block 106, an air intake manifold 108, an intake manifold cover 110 and an air intake supply conduit 112.

Within the air intake system 102 is an air heater system 114 positioned in the air flow (represented by arrows 104) passes through an air heater 116 of the air heater system 114 to heat the air prior to being combusted. The air heater system 114 includes an electronic control arrangement in the form of controller 118 that controls the supply of power to a heating element 120 of the air heater 116 to control heating of the air flow 104. Typically, the power is supplied by a power supply in the form of the electrical system of the device that is being powered by the engine system 100. For instance, power could be supplied by, as illustrated in FIG. 1, a battery 122. Alternatively or in addition, power could be supplied by a device such as an alternator (not shown), directly or indirectly through the battery 122. Various different controllers can be used in different embodiments of the invention.

The air heater system 114 may communicate with an electronic control unit of the overall device (i.e. an automobile) or other sensors to sense the temperature of the ambient air being supplied through the air intake system 102 as well as to determine the engine operating parameters of the engine system 100 (i.e. RPM, temperature, emissions, etc.).

In this embodiment, the air heater 116 is mounted to the air intake manifold cover 110. More particularly, the air heater 116 is mounted within an aperture through the air intake manifold cover 110.

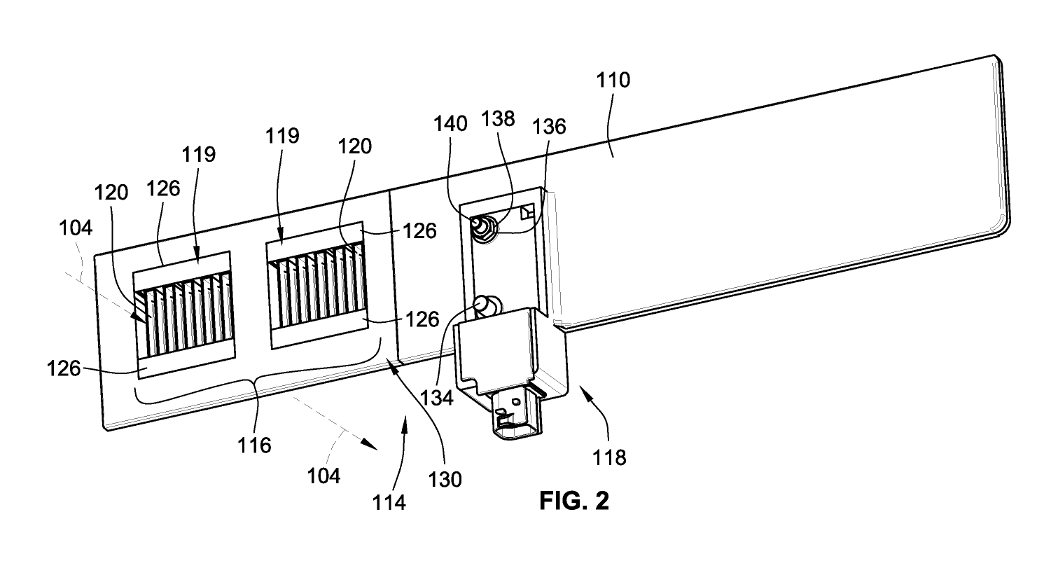

With reference to FIGS. 2 and 3, a more detailed illustration of an air intake manifold cover 110 having an air heater system 114 mounted thereto. In this embodiment, the air heater 116 includes two separate heater components that are operably connected together. Each component includes a pair of insulating mounts 126 that support a heating clement 120. The separate heater components are each mounted within an aperture 130 extending through the air intake manifold cover 110 through which intake air passes (see arrows 104) at which time it is heated if the controller 118 is supplying power to the heating elements 120.

The controller 118 includes an input electrical contact 134 to which a power cable connected to the power source (e.g. battery or alternator) can be connected. The controller 118 also includes an output electrical contact 136 that is electrically coupled to a contact screw 140 by a nut 138. The nut 138 is threaded onto contact screw 140 and biased axially against a contact surface of the output electrical contact 136.

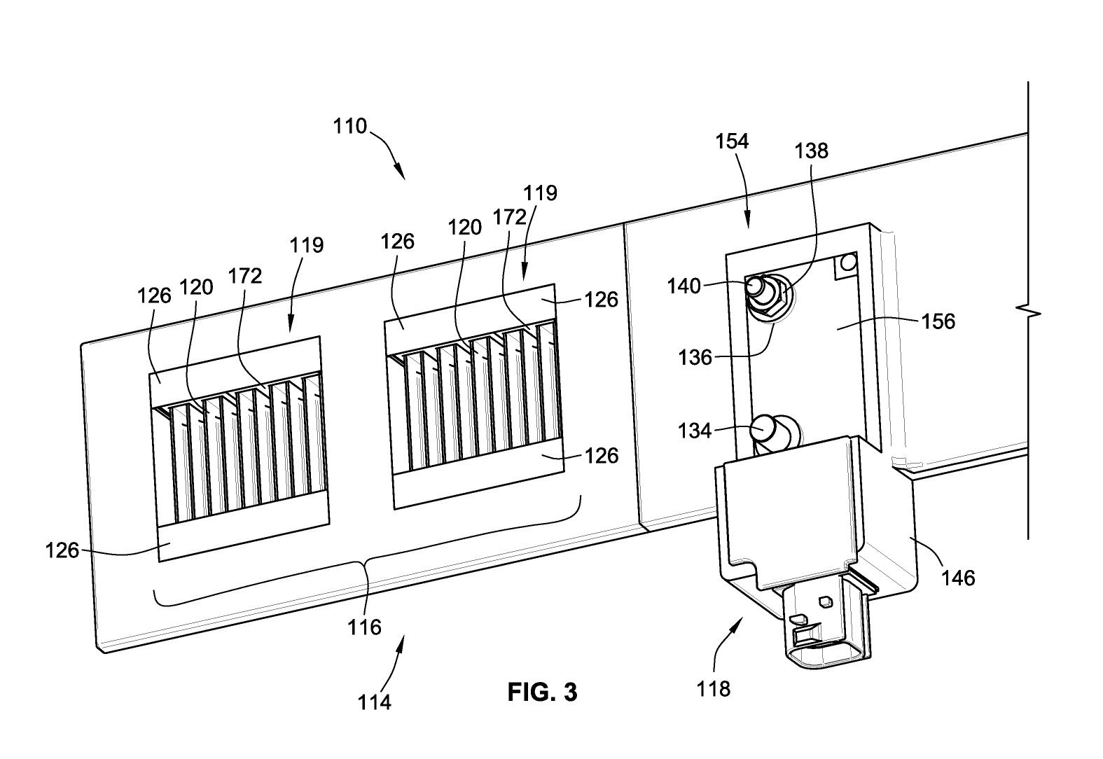

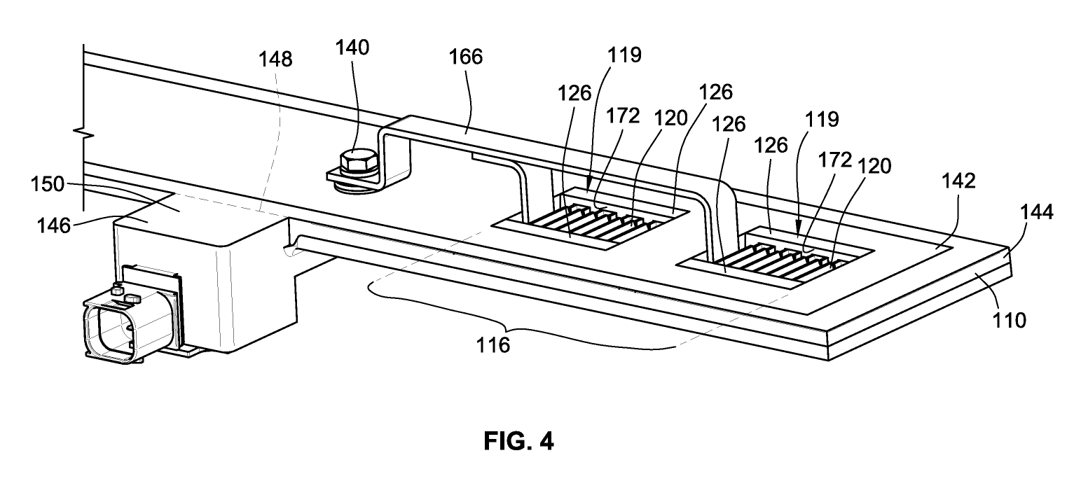

FIG. 4 illustrates an underside 142 of the air intake manifold cover 110 is illustrated. The underside 142 include a mounting surface 142 that will cooperate with the intake manifold 108 (see FIG. 1) or a gasket interposed therebetween. In this embodiment, the mounting surface 142 is generally rectangular in shape. However, the intake manifold cover 110 includes a laterally extending section 146 that extends laterally outward beyond the general rectangular periphery. Dashed line 148 helps illustrate the general rectangular periphery.

This laterally extending section 146 extends outward from the air intake manifold cover 110 in such a manner that when the air intake manifold cover 110 is mounted to the air intake manifold 108 (FIG. 1) the bottom surface 150 of this laterally extending section 146 is exposed to the ambient air surrounding the engine system 100. This laterally extending section 146 helps dissipate heat energy that may be generated by the controller 118.

With reference to FIGS. 2 and 3, in this embodiment, the air intake manifold cover 110 defines, at least part of, a housing 154 that defines an internal cavity in which a plurality of the electrical components of the air heater system 114 are located. In a preferred embodiment, the components of the controller 118 are permanently secured within the internal cavity of the housing 154 such that the controller 118 is permanently secured, at least in part, to the air intake manifold cover 110. In one embodiment, the components of the controller 118 are secured within the housing 154 by a thermal glue positioned between the components and the housing 154 Typically, the thermal glue will secure the printed circuit board of the controller 118 into the housing 154. Further, a sealant 156 will coat and further permanently secure the components within housing 151 and to the engine component. This arrangement integrates the controller 118 into the air intake manifold cover 110.

This arrangement improves the thermal cooling path, simplifies mounting, and improves vibration resistance of the controller 118. Further, this arrangement reduces the amount of space required by the controller, reduces overall weight, reduces prices for the consumer, provides improved spare part management for suppliers and optimizes the electrical connections to the related components, in this case the air heater 116. More particularly, this reduces the need for separate connection mechanisms to secure the controller 118 to the intake manifold cover 110. By eliminating the connectors, which are typically screws or bolts, it reduces the amount of components that can loosened due to vibrations or thermal dilatations. Also, there is no need to provide a higher level of effort in mounting the controller as there are no screws that need to be tightened to a prescribed torque to lock them.

The controller 118 is not removable from the air intake manifold cover 110 and is therefore an integral component of the air intake manifold cover 110. As such, in some embodiments, the controller 118 is of a solid state relay design that results in longer or equal life time of the controller as the air intake manifold cover 110.

While this embodiment integrates the controller 118 into an air intake manifold cover 110, the controller 118 could be formed in other internal combustion engine components such as, for non-limiting example, the air intake supply conduit 112 (see FIG. 1) or the air intake manifold 108 (see FIG. 1).

It has been found that the temperature of the air intake manifold cover 110, which is typically aluminum, helps dissipate any heat generated due to the controller or the thermal inefficiencies and parasitic resistance presented between the various electrical contacts of the air heater system 114 that supplies large currents to the heating elements 120.

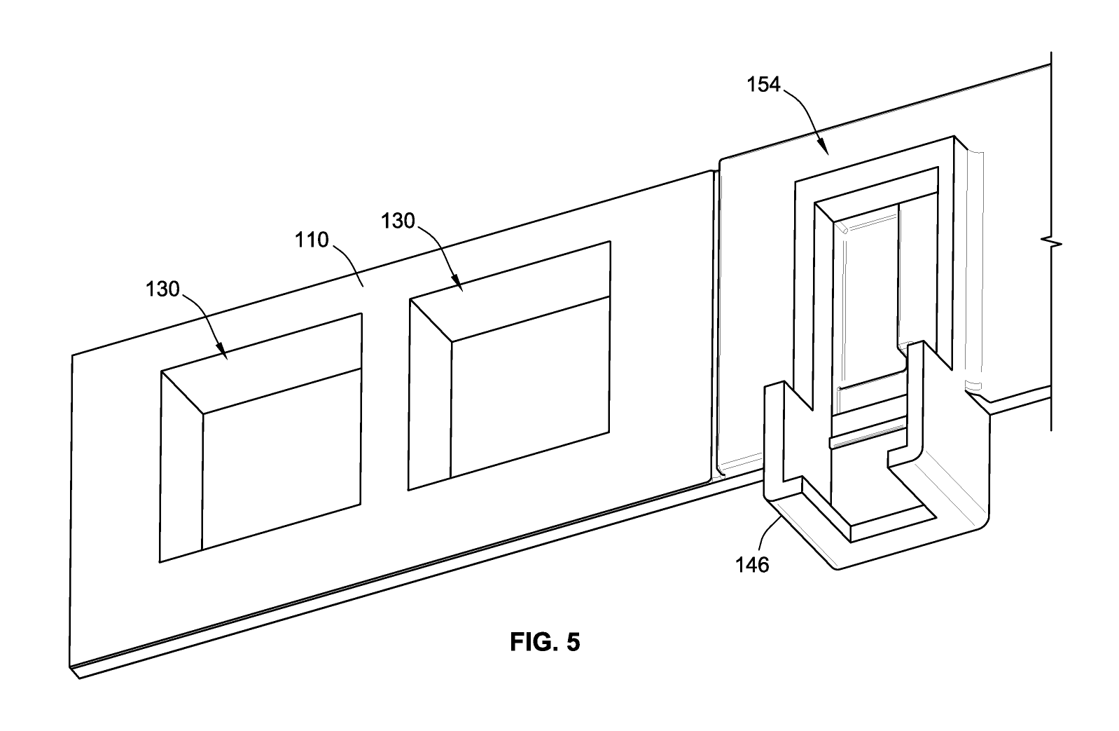

FIG. 5 illustrates the air intake manifold cover 110 with the rest of the air heater system 1111 removed. As such, the housing 154 and apertures 130 can be seen.

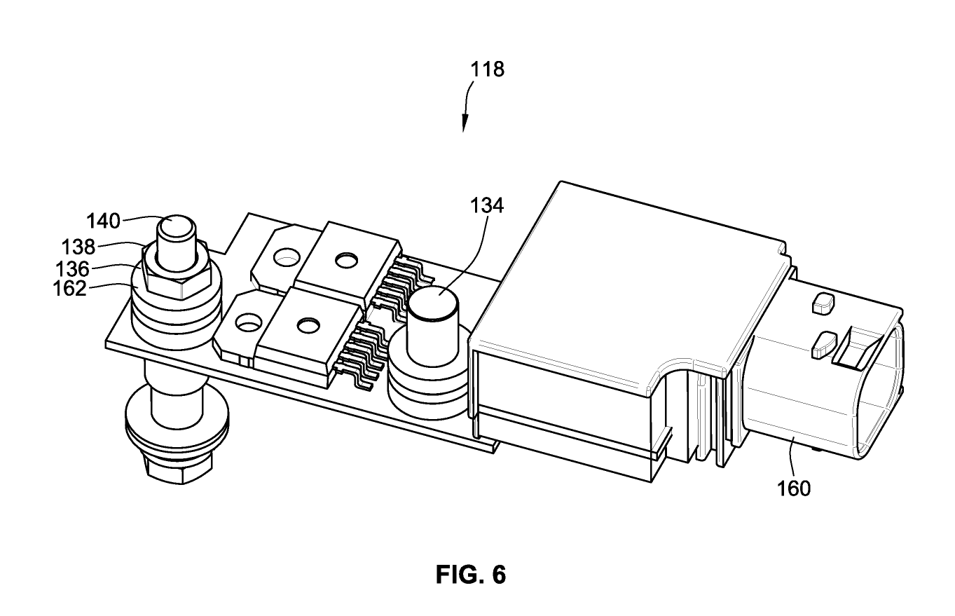

FIG. 6 illustrates, in simplified form, the controller 118 removed from the housing 154 and the sealant 156 removed. The controller 118 includes a connector 160 for connecting the controller to the electronic control unit of the engine or other control unit of the device powered by the engine. In this embodiment, the input electrical contact 134 is a threaded post. The output electrical contact 136 is in the form of the hollow contact that defines a top abutment surface 162 against which the nut 138 is axially biased to form the electrical connection between the controller 118 and the contact screw 140.

With additional reference to FIG. 7, the output electrical contact 136 includes a hole 164 configured to receive or slipover a contact screw, such as contact screw 140. The nut 138 would then again be axially tightened against 140 to form the electrical connection therebetween.

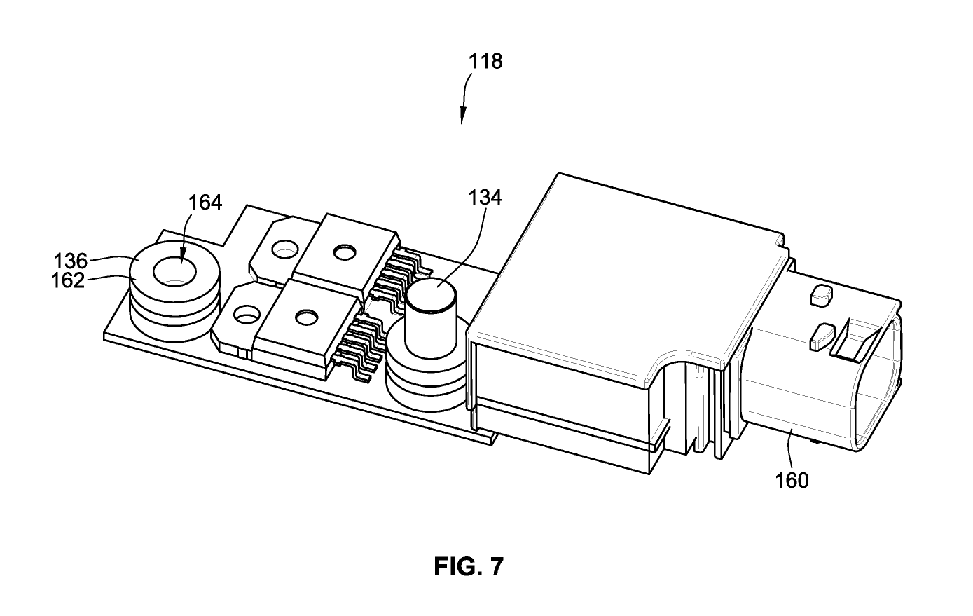

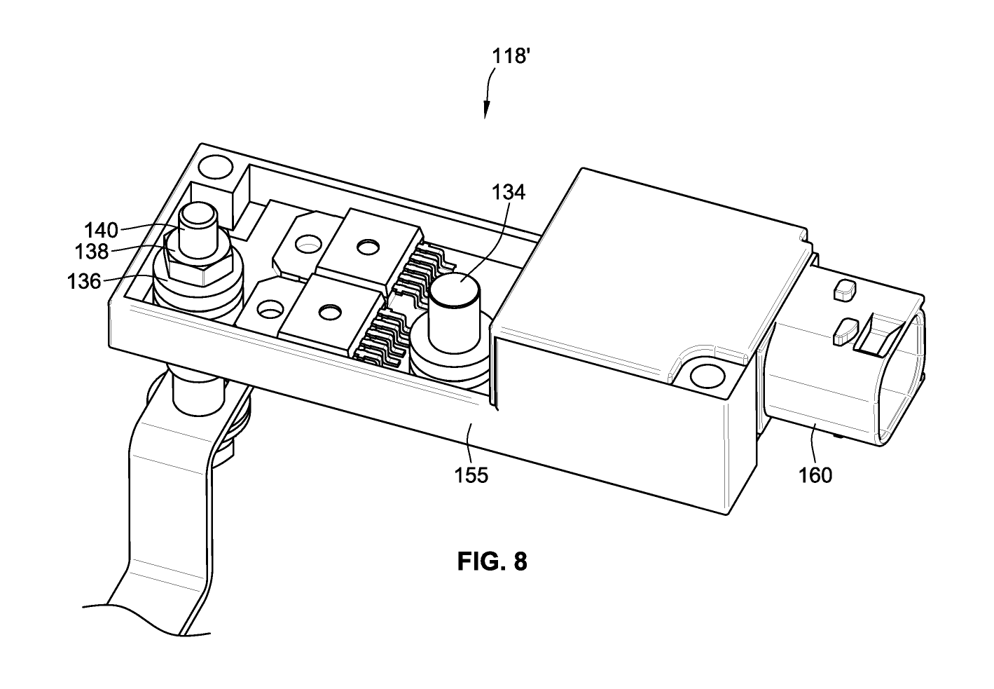

With reference to FIG. 8, in some embodiments, the controller 118′ may be a separate self-contained component from the air intake manifold cover 110. In this embodiment, the controller 118′ includes its own housing 155.

With reference to FIG. 4, the controller 118 is electrically connected to the air heater 116 by a connection member 166. More particularly, connection member 166 is connected to contact screw 140 which is in turn connected to output electrical contact 136 as discussed above. One end of the heating elements 120 is connected to an end of connection member 166 opposite the end that is proximate the controller 118. The other end of the heating elements 120 are electrically connected to the air intake manifold cover 110. This grounds the air heater 116. Alternatively, a connection member could directly connect heating element to controller such as using an intermediate nickel section welded directly to the heating element which would be directly or indirectly connected to a output electrical terminal of the controller. This nickel section is discussed in more detail below. Additionally, a connection member, in the form of a nickel segment, could be connected between the heating element and the engine component, i.e. on the ground side of the heating element.

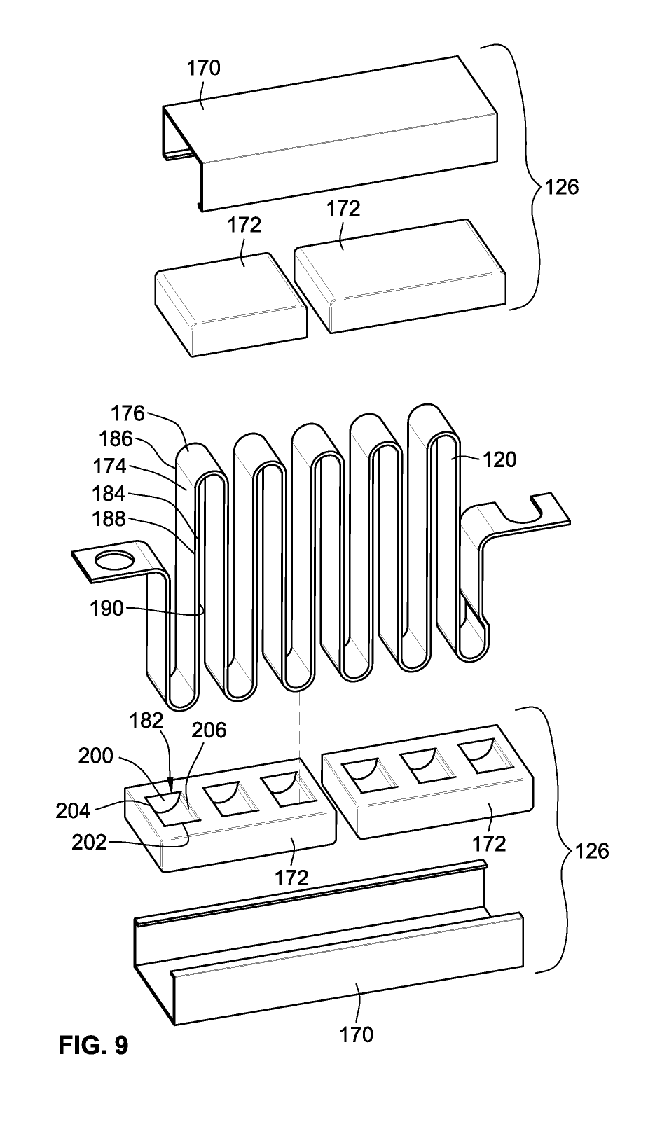

With reference to FIG. 9, each air heater component 119 generally includes the pair of insulating mounts 126 and the heating element 120. Each of the insulating mounts 126 typically includes a U-shaped carrier 170 that are typically stamped metal and one or more ceramic insulators 172. The heating element 120 is a ribbon of material that is formed into a plurality of longitudinally extending sections 174 that are interconnected with one another by a plurality of curved connection portions in the form of curved end sections 176 to form a wave-like or undulating profile. The insulators 172 (which could be other materials than ceramic) define generally rectangular receiving cavities 182 that receive the curved end sections 176 to support the heating element 120 and insulate the heating element 120 from the component of the engine to which the air heater 116 is mounted, i.e. the air intake manifold cover.

The longitudinally extending sections 174 each have an inlet end 184 and an outlet end 186. Parallel surfaces 188, 190 extend between the inlet and outlet ends 184, 186. The inlet ends 184 generally define an inlet face 192 of the air heater while the outlet ends 186 generally define an outlet face 194 of the air heater.

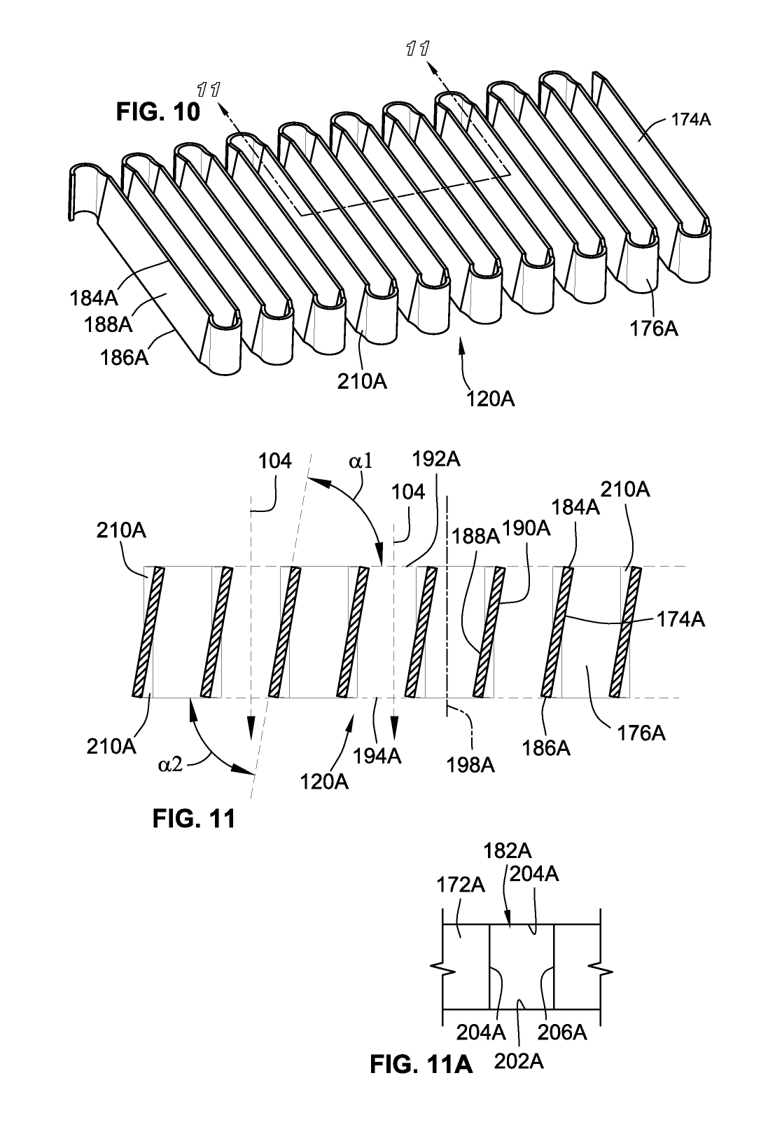

As noted above, it can be desirous to direct the air flow through the air heater 116. FIGS. 10 and 11 are partial illustrations of one embodiment of a heating element 120A configured to direct air flow as it flows through the heating element 120A. In this embodiment, the longitudinal extending sections 174A are slanted relative to the inlet and outlet faces of the heating element 120A.

Air flow is illustrated by arrow 104. In this embodiment, the longitudinally extending sections 174A define a guide face 188A between the inlet and outlet ends 184A, 186A. Here, the guide face 188A is planar surface and parallel to a back face 190A that is also a planar surface. The guide faces 188A and back faces 190A extend at a non-parallel, non-perpendicular angle α1 relative to the inlet face 192 of the heating element 120A. The inlet face 192 can be defined by a hypothetical planar surface that is set on the inlet ends 184A of the heating element 120A. Similarly, the guide faces 188A and back faces 190A extend at a non-parallel, non-perpendicular angle α2 relative to outlet face 194. In this embodiment, angles α1 and α2 are equal and are between 45 and 90 degrees and preferably about 60 to 85 degrees such that any air flow redirect is between about 0 and 45 degrees, preferably between about 15 and 30 degrees.

Due to the bending of the longitudinally extending sections 174A, transition sections 210A are formed between the curved end sections 176A and the longitudinally extending sections 174A. The transition sections 210A are twisted sections in the illustrated embodiment.

Typically, to form angles α1 and α2, the ribbon of material is typically bent to form curved end sections 176A first. Thereafter, the longitudinally extending sections 174A extending between the curved end sections 176A are bent to form angles α1 and α2.

This embodiment of a heating element 120A has the troughs 198 (i.e. bottoms) of the curved end sections 176 extending perpendicular to the inlet and outlet faces 192, 194. Further, this heating element 120A would use insulators 172 that have rectangular receiving cavities 182 that are not rotated such as illustrated in FIG. 9. More particularly, two sides 200, 202 of the rectangular receiving cavities 182 are parallel with one another and aligned (e.g. co-linear/co-planar) with the same sides of the rest of the rectangular receiving cavities 182. Further, the other two sides 204, 206 are parallel to one another but do not align with any of the sides of the other receiving cavities 182 and extend generally perpendicular to the inlet and outlet faces 192A, 194A when the heating element 120A is mounted within the insulators 172.

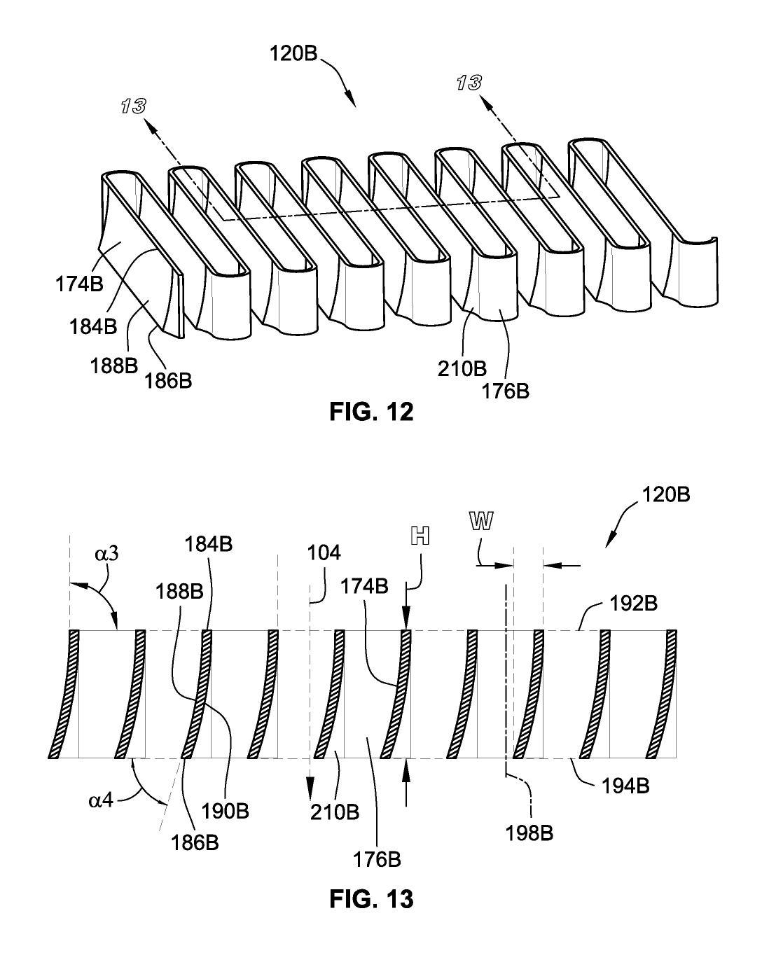

FIGS. 12 and 13 illustrate a further embodiment of a heating element 120B for directing air flow through the heating element 120B. In this embodiment, the longitudinally extending sections 174B are not planar between the inlet and outlet ends 184B, 186B. Instead, the guide faces 188B and back faces 190B of the longitudinally extending sections 174B are curved or rounded.

In this embodiment, the guide face 188B is substantially perpendicular to the inlet face 192B of the heating element 120B at the inlet end 184B, such that angle α3 is substantially 90 degrees, measured at the tangent of the face. However, in alternative embodiments angle α3 could have a non-perpendicular value such that the guide face makes more of a U-shape. The guide face 188B curves continuously in the direction of air flow 104 to outlet end 186B. The guide face 188B at the outlet end 190B extends at a non-parallel, non-perpendicular angle α4, measured at the tangent to the surface, relative to the outlet face 194B.

This embodiment would be formed similar to the prior embodiment 120A and has troughs 198B that are perpendicular to the inlet and outlet faces 192B, 194B. Additionally, this embodiment would use similarly shaped insulators 172 that use non-rotated rectangular receiving cavities. Further, this embodiment will have transition sections formed between the curved longitudinally extending sections 174B and the curved end sections 176B.

The guide face 188B would generally have a radius r. The radius r is preferably determined from the heating element width w and angle α4 using the following equation: r=(180w)/(πα4). Alternatively, the heating element width w could be calculated from available heating element height h using the following equation: w=(hα4π)/(180 sin(α4)).

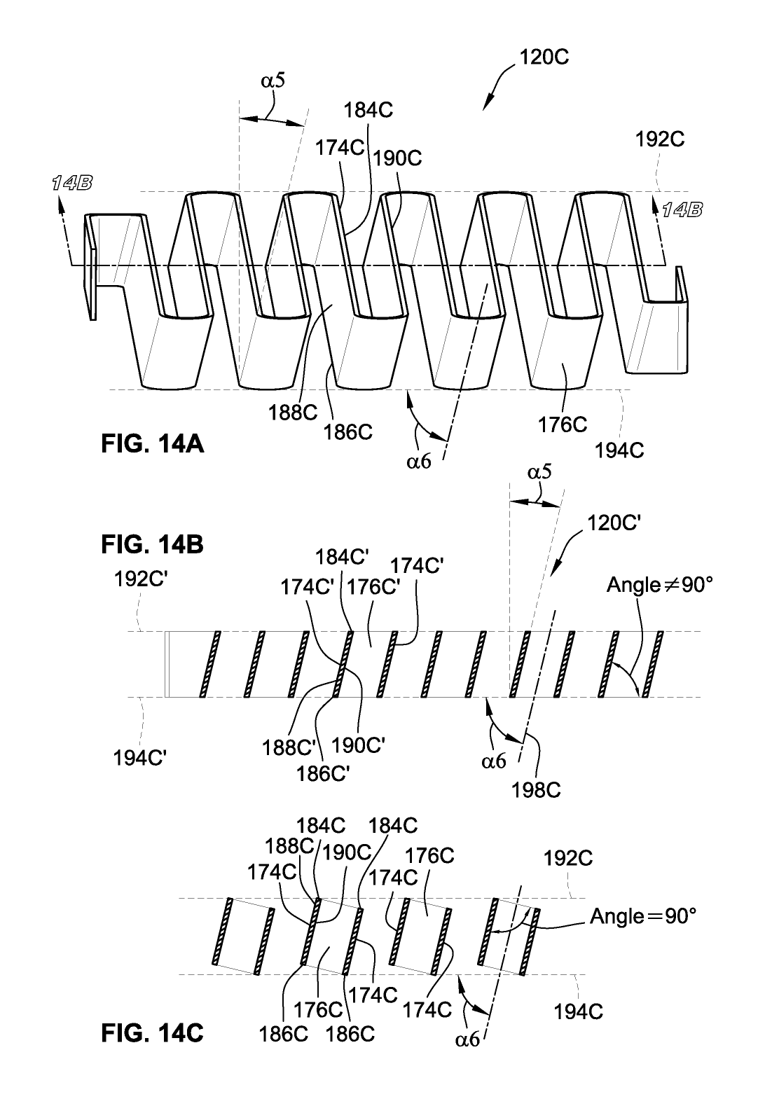

A further heating element 120C embodiment is illustrated in FIG. 14A-14C. This embodiment has substantially planar guide faces 188C and is similar to a standard undeformed heating element such as heating element 120 of FIG. 9. However, after forming the heating element 120 of FIG. 9, the heating element 120 is raked by an angle α5 such that the guide face 188C extends at an angle relative to the inlet face 192C and outlet face 194C. Due to the raking action, the troughs 198C of the curved end sections 176C are also angled relative to the inlet and outlet faces 192C, 194C at an angle αwhich is substantially equal to 90 degrees−angle α5. Preferably, angle α6 is between 45 and 90 degrees and preferably about 60 to 85 degrees such that any air flow redirection is between about 0 and 45 degrees, preferably between about 15 and 30 degrees. With reference to FIG. 14B, in some embodiments that utilize raking, the inlet ends 184C of adjacent longitudinally extending sections 174C adjacent a common curved section 176C will have different distances from the inlet face 192 due to the raking deformation. The same situation occurs for the outlet ends 186C. In this embodiment, the curved end sections 176C are generally rectangular when viewed from the end.

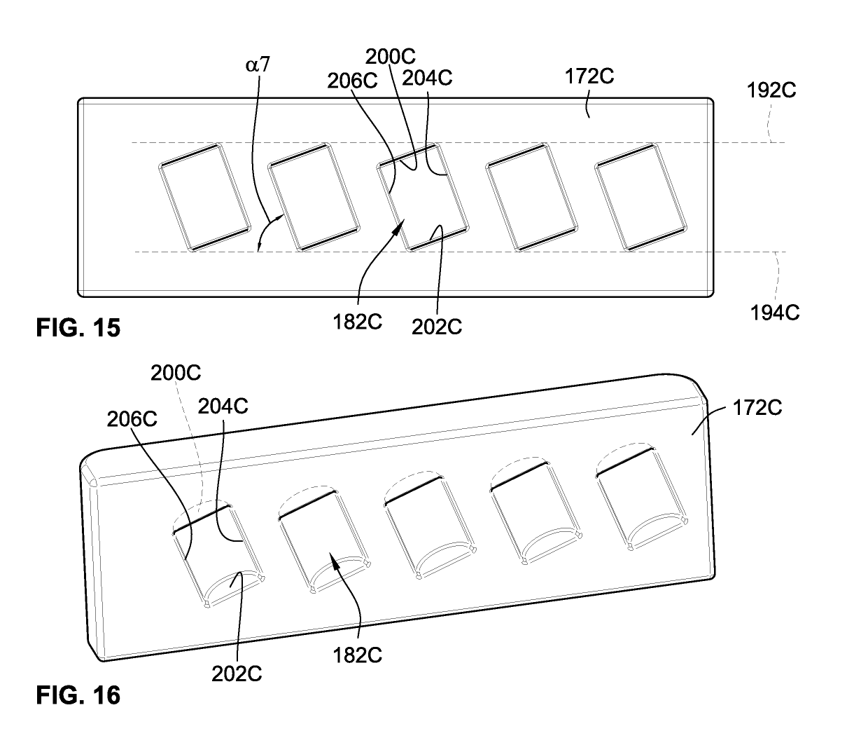

In this embodiment, the ceramic insulators 172 will have rotated rectangular receiving cavities such as illustrated in FIGS. 15 and 16. In this embodiment, the top and bottom sides 200C, 202C of the rectangular receiving cavities 182C all extend at non-parallel, non-perpendicular angles relative to the inlet and outlet faces 192C, 194C when the heating element 120C (not shown) is mounted within the receiving cavities 182C. Here, sides 204C, 206C extend at the angle α7 relative to the inlet and outlet faces 192C, 194C. Further, none of the top or bottom sides 200C, 202C are parallel with the corresponding sides of adjacent cavities 182C such as in the insulator 172 illustrated in FIG. 9.

However, in alternative embodiments, the raking action may occur such that the end view of the curved section 176C′ looks like a non-rectangular parallelogram, such as illustrated in FIG. 14C. In this situation, the cavities in a corresponding insulator would have a similar non-rectangular parallelogram shape. Further, the inlet ends 184C′ for all of the longitudinally extending sections 174C′ have a same distance relative to the inlet face 192C′ and the outlet ends 186C′ have a same distance from the outlet face 194C′. However, the trough of the curved sections 176C′ still extends at an angle relative to the inlet and outlet faces 192C′, 194C′.

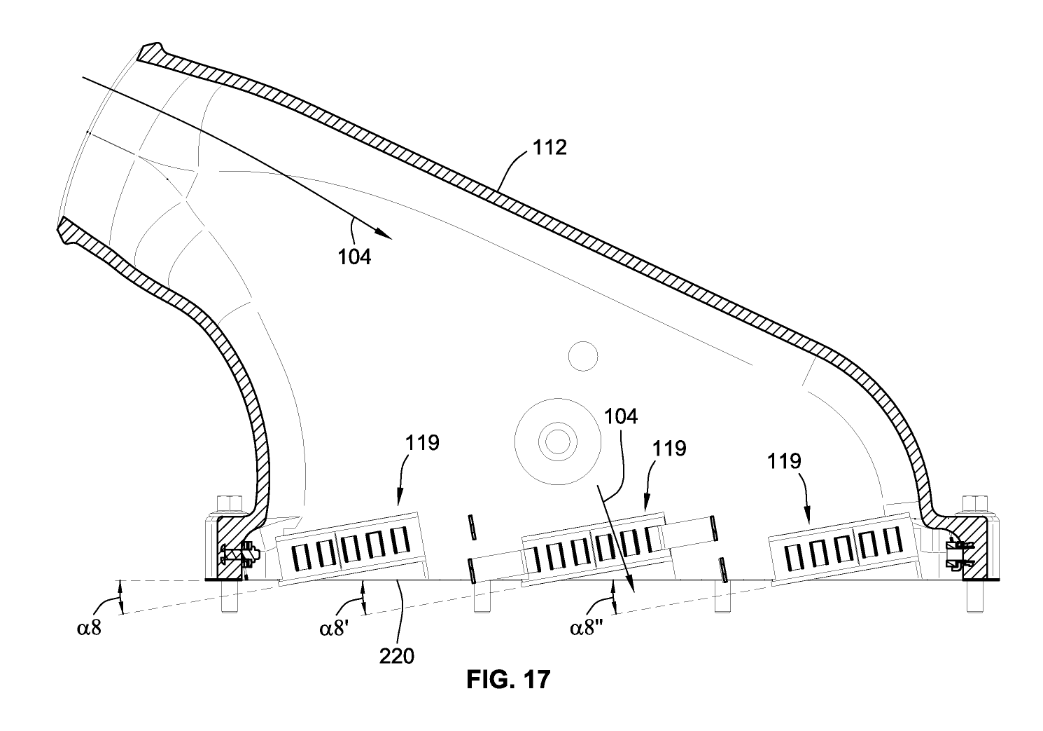

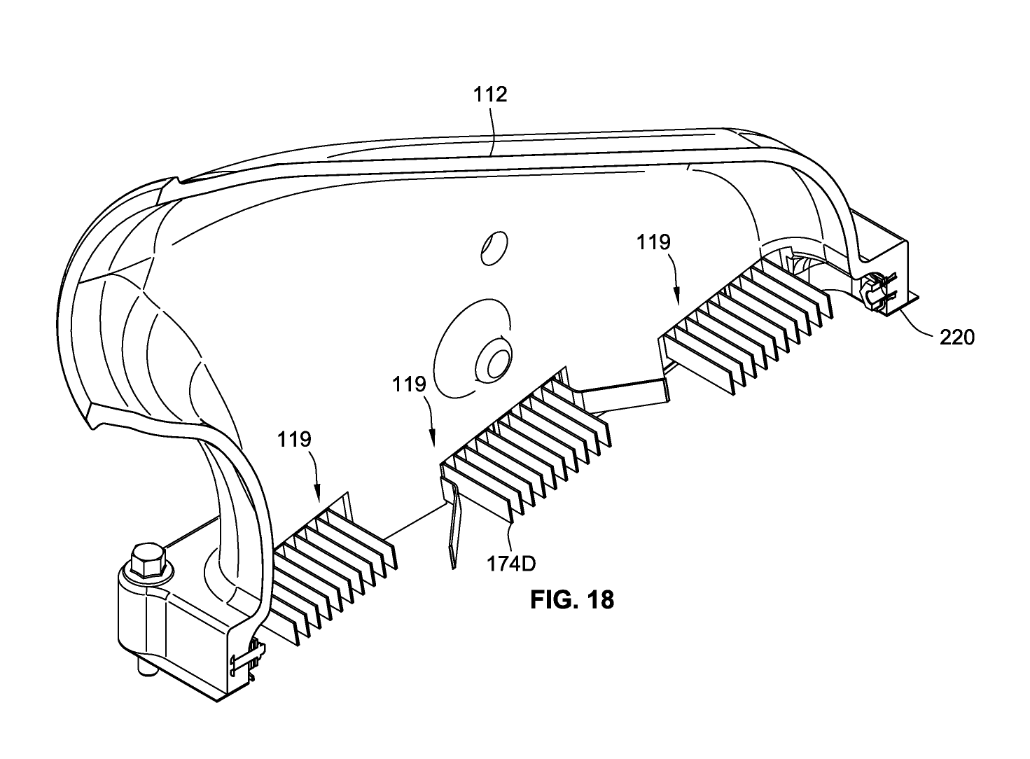

A fourth method of deflecting the air flow 104 as it flows using the air heater is illustrated in FIGS. 17 and 18. In this embodiment, the air heater sections 119 are mounted at an angle a relative to a mounting surface 220 of the internal combustion engine component to which they are mounted. In this embodiment, the internal combustion engine component is an air intake supply conduit 112.

As such, rather than deforming the heating element 1201) as in the prior embodiments and particularly the longitudinal extending sections thereof, the orientation of the heating section 119 is merely altered so as to change the orientation of the air flow 104 as it exits the engine component (i.e. air intake supply conduit 112). In this embodiment, the insulating mounts 126 are mounted to angle the longitudinally extending sections, and particularly the guide faces thereof, relative to the mounting surface 220.

While this embodiment has the heating sections 119 mounted in the intake supply conduit 112 other embodiments could incorporate the heating sections in such a slanted configuration in other components such as the air intake manifold cover 110.

Further, angles α8, α8′ and α8″ in FIGS. 17 and 18 are shown equal. However, in alternative embodiments, these angles α8, α8′ and α8″ could differ to each other in a way that each heating section 119 redirects the air flow in a more controlled manner. For instance, different heaters could be aimed to direct portions of the air flow at different engine cylinder air intake ports.

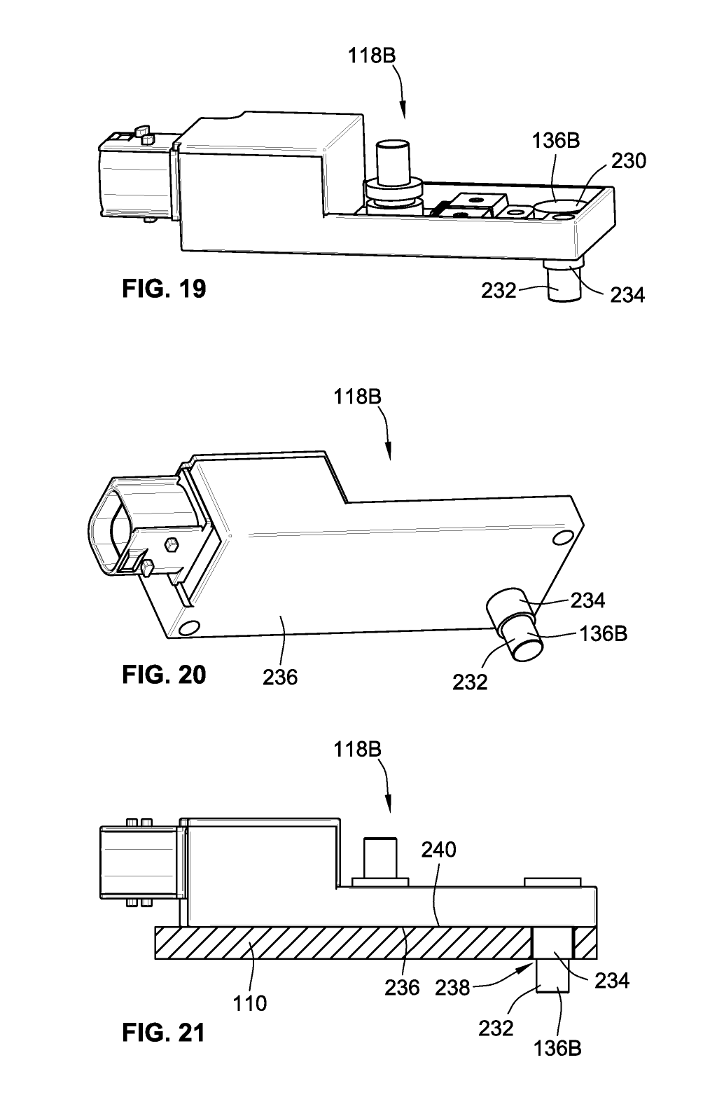

FIGS. 19-21 illustrate an alternative embodiment of a controller 118B. This embodiment modifies the output electrical contact 136B. In this embodiment, the output electrical contact 136B is in the form of an electrical contact screw that has an enlarged head portion 230 attached to a threaded stud shaft 232. An electrical lead, such as connection member 166 of the air heater can be connected to the controller 118B.

This embodiment is also a standalone controller that can be formed separately from the engine component to which it is mounted and subsequently attached to the component.

Surrounding the stud shaft 232 is a cylindrical insulator 234. The cylindrical insulator 234 insulates the stud shaft 232 from the internal combustion engine component (such as air intake manifold cover 110) to which the controller 118B would be mounted. The cylindrical insulator 234 would be sized to be inserted into a hole 238 through a mounting surface 240 of the internal combustion engine component (110). Preferably, the diameter of the insulator 234 would match the diameter of the hole 238 so that the insulator 234 would provide increased mechanical stiffness to the system.

In this embodiment, the controller 118B has a bottom mounting surface 236 that would be mounted against the component of the internal combustion engine during assembly. In this embodiment, the bottom mounting surface 236 is provided by a housing that houses other internal electrical components of the controller 118B.

The output electrical contact 136B could also be incorporated into a controller that is permanently secured to the component of the internal combustion engine such as controller 136 discussed above.

The use of this type of electrical contact reduces the number of pares needed for reliable electric/mechanic connection along with minimized parasitic resistance due to the electrical connection.

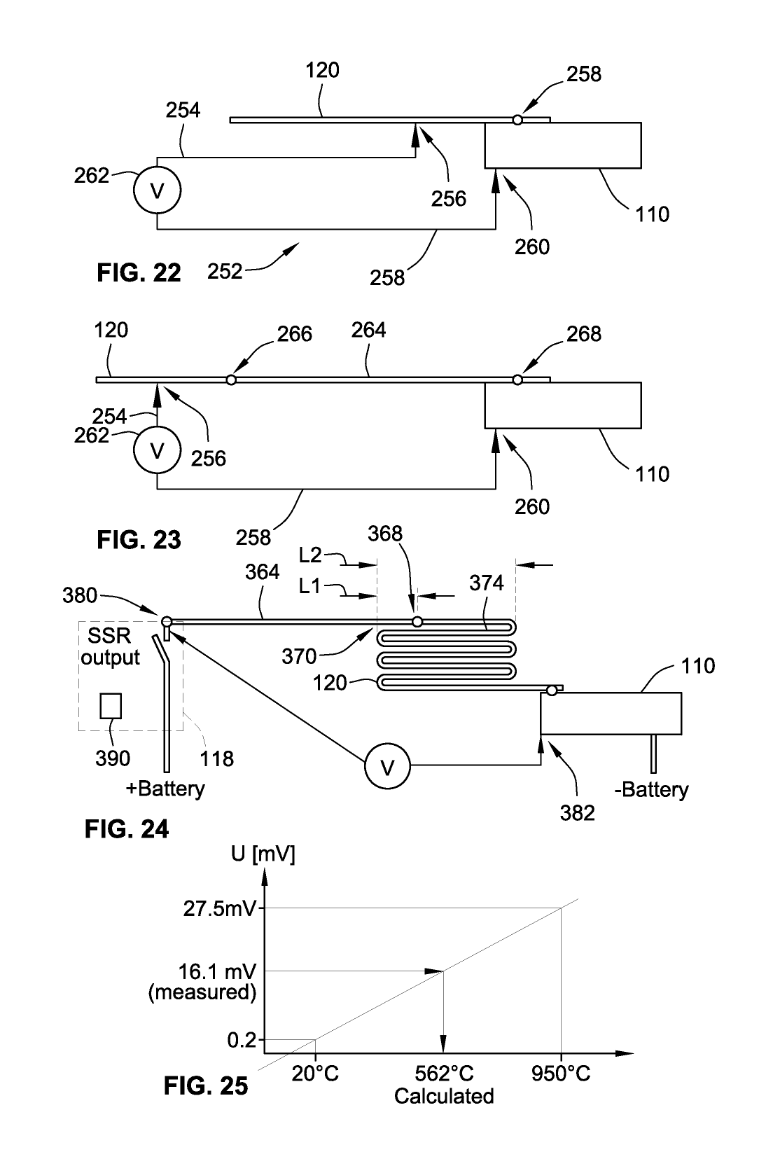

FIG. 22 illustrates a further feature of an embodiment of the invention. It is often important to know the temperature of the heating element 120. As such, in one embodiment, the controller 118 is configured to sense the temperature of the heating clement 120 using thermocouple principles and particularly at the thermal junction 250 between the heating element 120 and air intake manifold cover 110 (or other internal combustion engine component to which the heating element 120 is grounded).

In this arrangement, the heating element 120 and the air intake manifold cover 110 are formed from different materials. When the thermal junction 250 between heating element 120 and air intake manifold cover 110 is exposed to a temperature different than the temperature at the electrical junctions 256, 260, a thermocouple voltage is generated that correlates to the temperature differential between electrical junctions 256, 260 and the thermal junction 250.

The arrangement includes a thermocouple circuit 252 to measure the voltage across the thermal junction 250. The thermocouple circuit 252 includes a first lead 254 coupled to the heating element 120 at a first electrical junction 256. The thermocouple circuit 252 also includes a second lead 258 coupled to the air intake manifold cover 110 at a second electrical junction 260. Finally, a voltmeter 262 is connected to the opposed ends of the first and second leads 254, 258 to measure the thermocouple voltage generated between the two electrical junctions 256, 260. While the drawings illustrate voltmeter 262 as a separate component, voltmeter 262 could be provided by the circuitry of the controller 118 and need not be a separate independent component. In other words, the voltmeter need not be, and typically would not be, a separate multi-meter.

From this thermocouple voltage, a temperature of the thermal junction 250 can be determined. Alternatively, the thermocouple voltage can be used as it correlates to the temperature of the thermal junction 250. If the reference temperature of the electrical junctions 256, 260 is known, the temperature of the thermal junction 250 can be determined. As such, the temperature of the heating element 120 at the thermal junction 250 is known. This temperature data can be used to control operation of the air heater system by the controller 118 or a higher level electronic control unit of the overall device.

The temperature data that is sensed relating to the thermal junction 250 will typically occur when power is not being supplied to the heating element 120.

FIG. 23 illustrates a further embodiment similar to that of FIG. 22. In this embodiment, an intermediate segment 264 is interposed between the heating element 120 and the air intake manifold cover 110 (or other engine component). The heating element 120, intermediate segment 264 and the air intake manifold cover 110 are all formed from different materials.

A first thermal junction 266 is formed between the heating element 120 and the intermediate segment 264. A second thermal junction 268 is formed between the intermediate segment 264 and the air intake manifold cover 110.

In this arrangement, two thermal junctions 266, 268 are positioned between electrical junctions 256, 260. In this arrangement, there is higher sensitivity to temperature variations and the temperature is measured at the end of the heating element 120 rather than at the air intake manifold cover which is a much larger block of material and less sensitive to changes in the temperature of the heating element.

Again, the voltage information gathered from the voltmeter 262 can be used to control operation of the air heater.

FIG. 74 illustrates a further embodiment similar to FIGS. 22 and 23 that includes a thermal junction arrangement for determining the temperature of the heating element 120. In this embodiment, the intermediate segment 364 is located between the controller 118 (illustrated in simplified form and dashed lines) and the heating element 120. More particularly, the intermediate segment 364 is connected between the output electrical contact of the controller 118 and the heating element 120. Intermediate segment 364 forms part of the connection member between the controller 118 and the heating element 120.

In this embodiment, the end portion 370 of the intermediate segment 364 that connects to the heating element 120 over laps with a portion of an adjacent longitudinally extending section 374. This allows for a more accurate temperature reading at thermal junction 368. In one embodiment, the length L1 of the end portion 370 that overlaps adjacent longitudinally extending section 374 is at least 25% of the length L2 of the longitudinally extending section 374. However, alternative embodiments could have more or less overlap or no overlap at all.

The temperature at the first and second electrical junctions 380, 382 will generally be significantly lower than the temperature of the heating element 120 and approximately between 8-11 times less than the temperature of the heating element 120. For instance, the temperature at electrical junctions 380, 382 can be between −40 degrees Celsius and 125 degrees Celsius while the temperature at the thermal junction 368 can typically he between 500 and 1200 degrees Celsius and more typically between 600 and 1000 degrees Celsius. As such, there is a large temperature differential between electrical junctions 380, 382 and the principal thermal junction 368.

Again, the temperature measurement of the heating element 120 is ultimately determined by measuring the voltage between the electrical junctions 380, 382. Other circuitry within the controller 118 may be used to determine the temperature or estimate the temperature at one or both of these electrical junctions 380, 382, which are often referred to as cold junctions.

Further, the controller 118 may include a negative temperature coefficient resistor 390 (or other method of measuring temperature within or adjacent to the controller 118) to measure the temperature of the controller, and particularly the components forming the cold junction 380. As such, the controller 118 will have available data of the temperature within the controller 118. Thus, the temperature of at least the first electrical junction 380 will be well known. Further, the temperature of the engine component, i.e. intake manifold cover 110, will be substantially similar to that temperature within controller 118. By using the internal temperature of the controller 118, the temperature value of heating element 120 can be compensated to eliminate or significantly reduce the effect of the cold junctions and thus improve the accuracy of the temperature measurement at thermal junction 368.

In one embodiment, the intermediate segments 264, 364 are formed from Nickel while the heating element 120 is formed from Kanthal. Preferably, a thermocouple is formed from alloys that have very precise and stable structure. This is not the case when using commercially available alloys in ribbon form predominantly intended for heating purposes. Therefore, different thermocouple voltages at the same air heater temperatures may be expected from part to part.

As such, a further feature of an embodiment of the present invention is to provide for end of the line calibration of the temperature measurements of the heating element, i.e. at thermal junctions 266, 368.

After formation of each heating element, each heating element is typically tested. At this time, the calibration can also occur.

During calibration, a reference temperature probe is inserted into the heating element 120 of the air heater at room temperature. A thermocouple voltage inside the controller is then linked with the temperature reading from the reference temperature probe and stored in a microcontroller non-volatile memory of controller 118. The same procedure is performed at higher temperature, e.g. at 900 degrees Celsius. This information is again stored in the microcontroller non-volatile memory of controller 118.

Thermocouple voltage dependence on temperature typically has a linear behavior. As such, intermediate values can be created by interpolation. For example and with reference to FIG. 75, if the room temperature measurement provided values of T₀=20° C.; U₀=0.2 mV; T₁=950° C.; U₁=27.5 mV; then ΔT=T₁−T₀=930K and ΔU=U₁−U₀=27.3 mV.

The equation of the straight line through both measured points is:

$${U}_{measured} - {U}_{o} = \frac{Δ U}{Δ T} ( {T}_{calculated} - {T}_{0} )$$

Thus, the equation for T_{calculated} is:

$${T}_{calculated} = \frac{{U}_{measured} - {U}_{o} + \frac{Δ U}{Δ T} {T}_{0}}{\frac{Δ U}{Δ T}}$$

As such, if a measured value of 16.1 mV is sensed in operation, the temperature of the heating element would be determined to be approximately 562° C.

If ΔU/ΔT is marked as k we get simplified equation for calculation of temperature:

$${T}_{calculated} = \frac{{U}_{measured} - {U}_{o} + {kT}_{0}}{k}$$

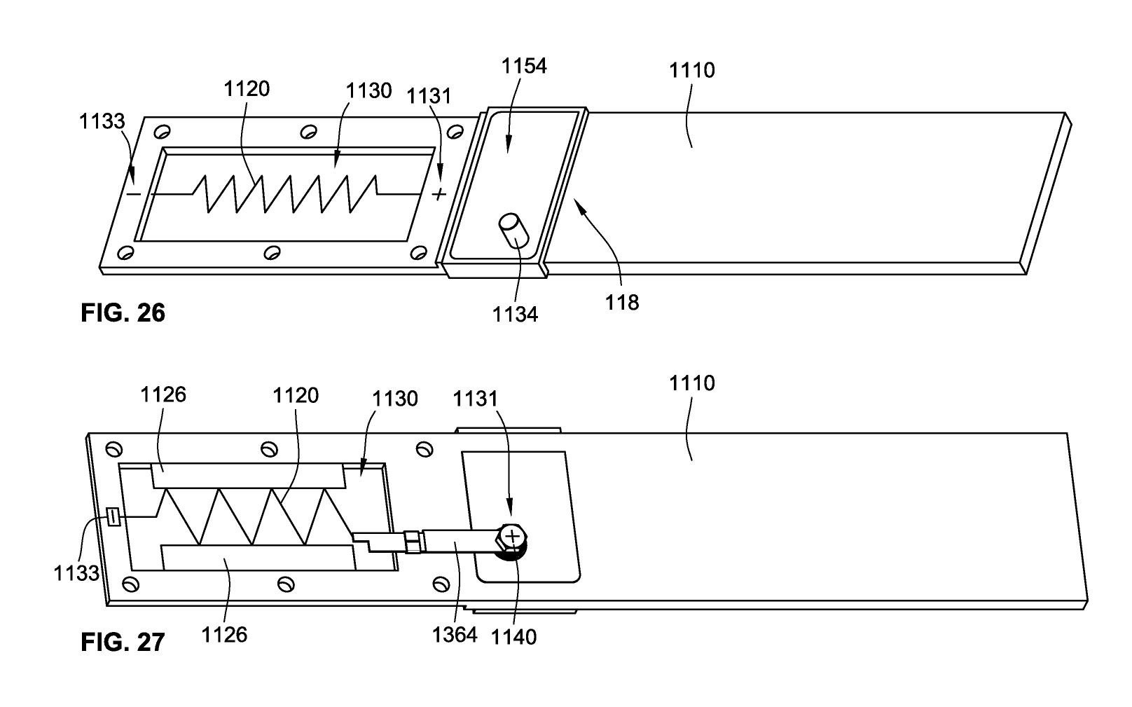

FIG. 26 illustrates an alternative embodiment of an engine component and controller combination. This embodiment is similar to that discussed with reference to FIGS. 1-5 above. In this embodiment, the engine component is an air intake manifold cover 1110 that has an integrated controller 1118.

The heating element 1120 is illustrated in simplified form mounted within aperture 1130. In this embodiment, the heating element 1120 is a single heating element such that the positive connection 1131 is on one side of the aperture 1130 proximate controller 1118 and the negative connection 1133, e.g. ground, of the heating element 1120 is on the opposite side of aperture 1130.

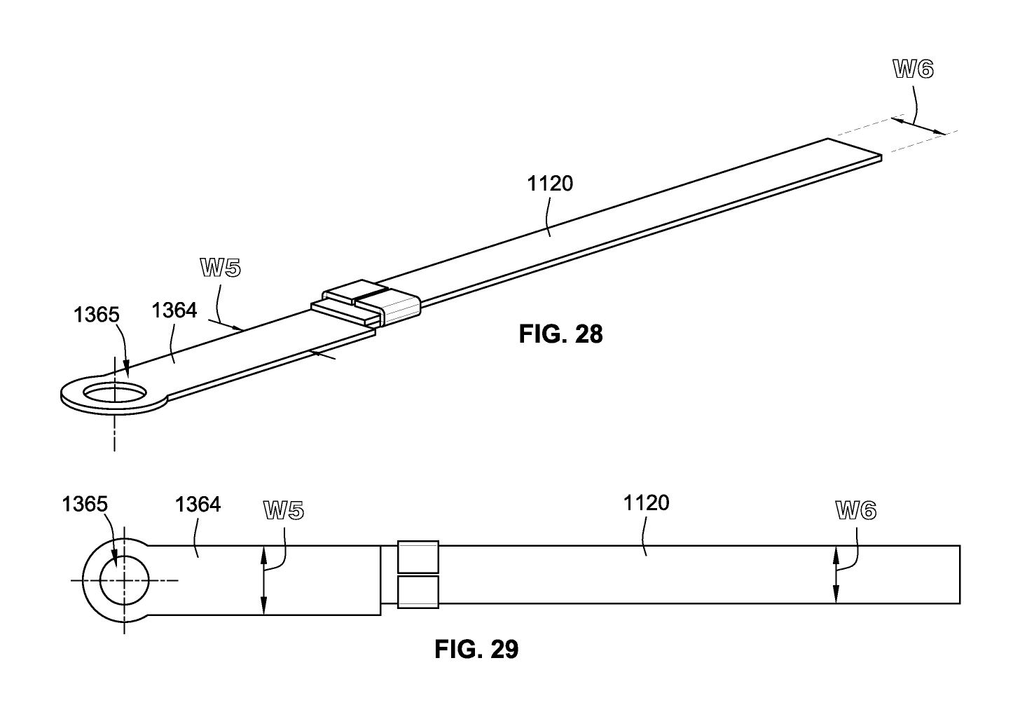

FIG. 27 illustrates an underside or mounting side of the air intake manifold cover 1110 The heating element 1120 is mounted in insulating mounts 1126 like the prior embodiments. In this embodiment, an intermediate segment 1364 is interconnected between the heating element 1120 and the controller 1118. Preferably, this intermediate segment 1364 is formed from Nickel as discussed above. FIGS. 28 and 29 are partial illustrations of the intermediate segment 1364 coupled to a portion of heating element 1120.

Preferably, the cross-section of the intermediate segment 1364, and particularly width W5, is greater than the cross-section of the ribbon forming heating element 120. This structural relationship reduces the resistance within the intermediate segment 1364 so as to avoid significant heat production from the intermediate segment 1364.

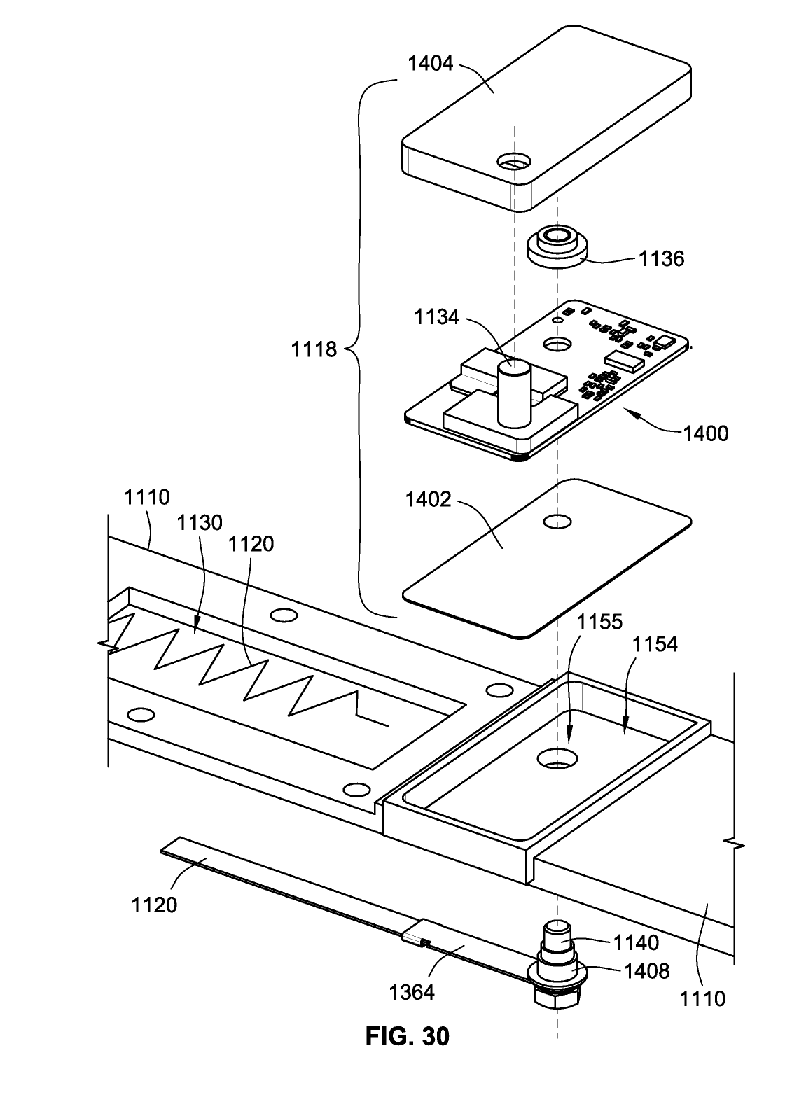

The intermediate segment 1364 includes an aperture 1365 for receipt of a connection bolt or screw 1140 (See FIGS. 27 and 30).

The controller 1118 of this embodiment is integrated into the engine component, e.g. air intake manifold cover 1110, such that the controller 1118 cannot be removed from the air intake manifold cover 1110. One significant benefit, but not the only benefit, is that the engine component can be used as a large heat sink to remove heat energy generated by the controller 1118.

FIG. 30 illustrates the components in an exploded view. The air intake manifold cover 1110 defines a housing 1154 molded directly into the component. The housing 1154 includes an aperture 1155 through the component for receipt of the contact bolt 1140 from the underside or bottom side of the air intake manifold cover 1110.

The controller 1118 includes an input electrical contact 1134 and an output electrical contact 1136. In this embodiment, the output electrical contact 1136 is in the form of a threaded connector that is internally threaded for connection with contact bolt 1140. An electrical threadlock material can be applied between the output electrical contact 1136 and the contact bolt 1140 to prevent loosening of the connection due to vibrations and to reduce any contact resistance between the components.

The controller 1118 includes a printed circuit board 1400 to which the input and output electrical contacts 1134, 1136 are mounted. A layer of thermal glue 1402 or other thermal material is positioned between the bottom of the printed circuit board 1400 and the air intake manifold cover 1110 to assist in dispersing the heat energy generated by the controller 1118.

The electronic components of the controller 1118 are sealed or encapsulated within the housing 1154 by a sealant 1404. Typically, the sealant is poured into the housing and then cures to permanently secure the components of the controller 1118 into housing 1154 and to prevent any liquid ingress. Alternative embodiments, may utilize screws to secure the printed circuit board 1400 to the air intake manifold cover 1110 and thermal gel or paste is used to help dissipate heat to the engine component. However, the sealant will be applied over these components to again secure the controller 1118 to the engine component and to prevent any liquid ingress.

An insulator 1408 will separate the contact bolt 1140 from the metal engine component as the contact bolt 1140 extends through aperture 1155. The insulator 1155 and/or the sealant 1404 help seal aperture 1155 so as to avoid pressure losses within the air intake manifold through the controller 1118.

As noted above, one of the issues with air heater systems as described above is the delay required to preheat the heating element (also referred to as a heating ribbon) at engine start, which creates several problems. The following will describe embodiments of control strategies to overcome one or more of the issues discussed above.

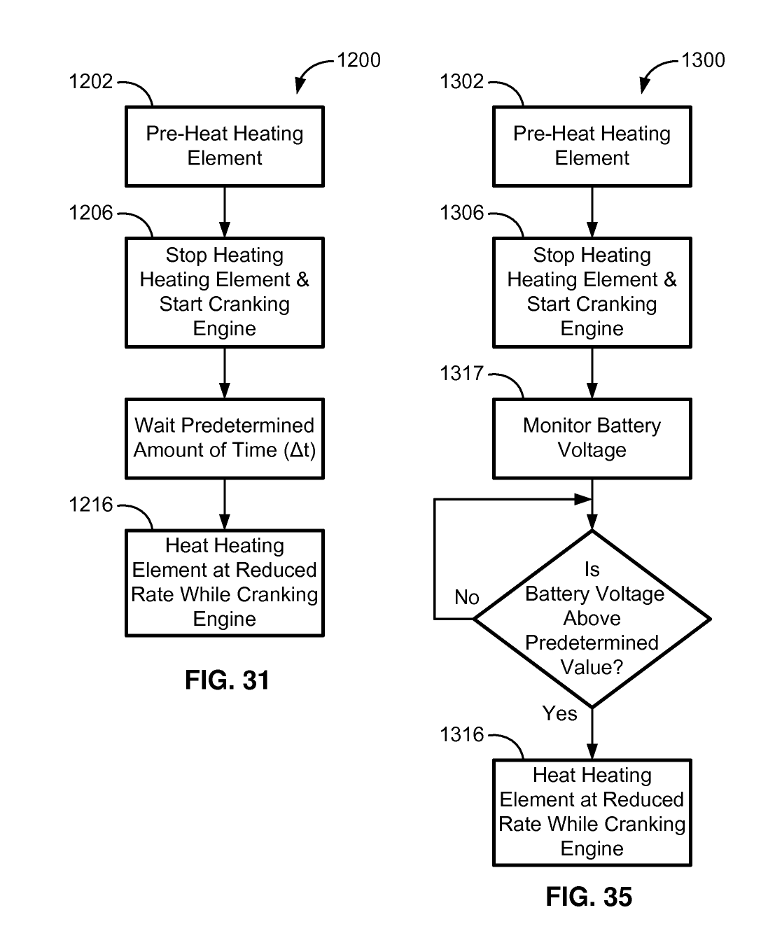

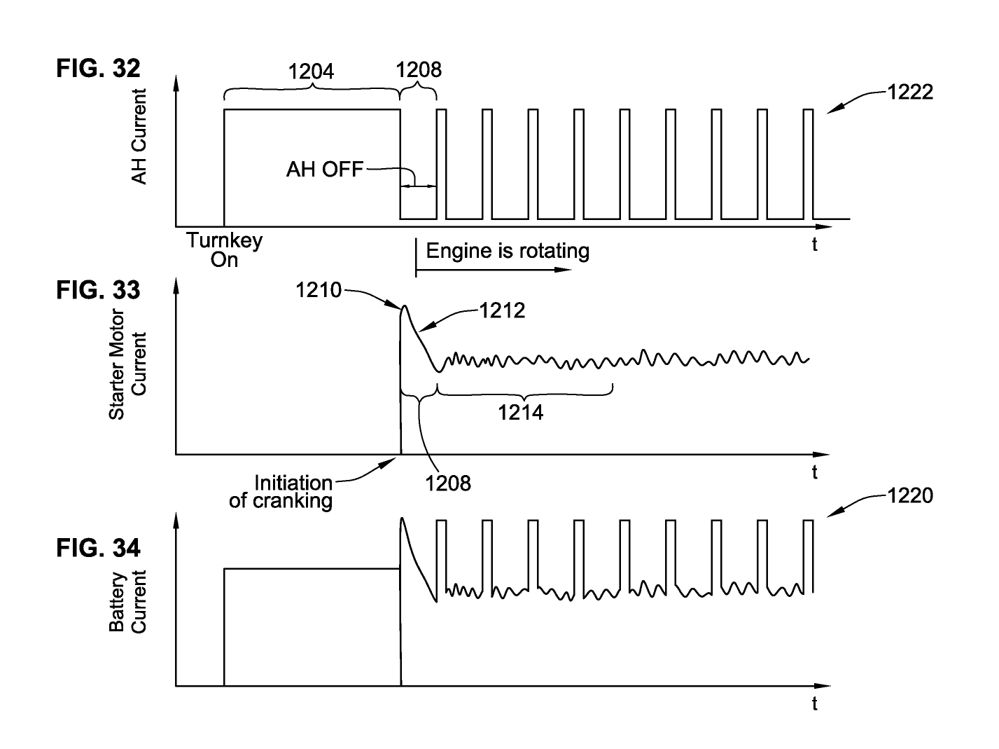

A first control strategy 1200 is illustrated in the flowchart of FIG. 31. The control strategy 1200 relates to the operation of the air heater system and particularly when power is supplied to the air heater. FIGS. 32-34 illustrate the current vs time through the air heater (FIG. 32), the starter motor (FIG. 33) and battery (FIG. 34) during engine start.

At engine start, the first step 1202 includes preheating the heating element of an air heater for a predetermined amount of time after engine start is initiated (e.g. by turning of a key), illustrated by bracket 1204 in FIG. 32. The heating element will be heated at maximum current for the predetermined amount of time 1204 after the key is turned on. At this time, the current to the starter motor will be zero.

After the predetermined amount of time 1204 expires, the second step 1206 includes stopping the supply of current to the air heater heating element, which will remain stopped for second predetermined amount of time, illustrated by bracket 1208. At this time, current is supplied to the starter motor of the engine, illustrated by current spike 1210 in FIG. 33 for the starter motor. The current to the air heater is stopped at this time to avoid an overload on the battery due to the high current draw as the starter motor begins to crank the engine. After the initial current spike 1210 and the engine begins to rotate, the current through the starter motor begins to drop, as illustrated by section 1212 of FIG. 33. This is because there is less load on the starter motor. In some embodiments, the second predetermined amount of time is approximately 0.5 seconds but can vary depending on the application, and particularly the profile of the current drop from spike 1210 to section 1214 in FIG. 33.

After the second predetermined amount of time 1208, the current draw by the starter motor has a substantially reduced and substantially constant draw illustrated by section 1214 in FIG. 33. After the second predetermined amount of time 1208, the next step 1216 is to begin supplying current to the heating element again. However, at this time, the air heater will not be supplied full power. Typically, pulse-width-modulation (“PWM) will be used such that short bursts of full current will be supplied to the air heater such that the average power supplied to the air heater is approximately between about 10% and 50% of full power and more preferably between about 20% and 40% full power while the starter motor continues to crank the engine However, PWM need not be used. FIG. 34 illustrates current spikes 1220 that correspond to the PWM spikes 1222 of the current to the air healer.

Because the air heater receives current while the starter motor is rotating, after the starter motor current has dropped below peak 1210 less heat accumulation is necessary within the heating element of the air heater. As such, the first predetermined amount of time 1204 before activating the starter motor at peak 1210 can be shorted. Alternatively, the heating element can be reduced in size because less heat accumulation need be provided by the heating element as the heating element will be provided power while the starter motor cranks the engine. Alternatively, a combination of these two benefits can be provided. More particularly the heating element could be made smaller to save money and the initial pre-heat time 1204 can be reduced.

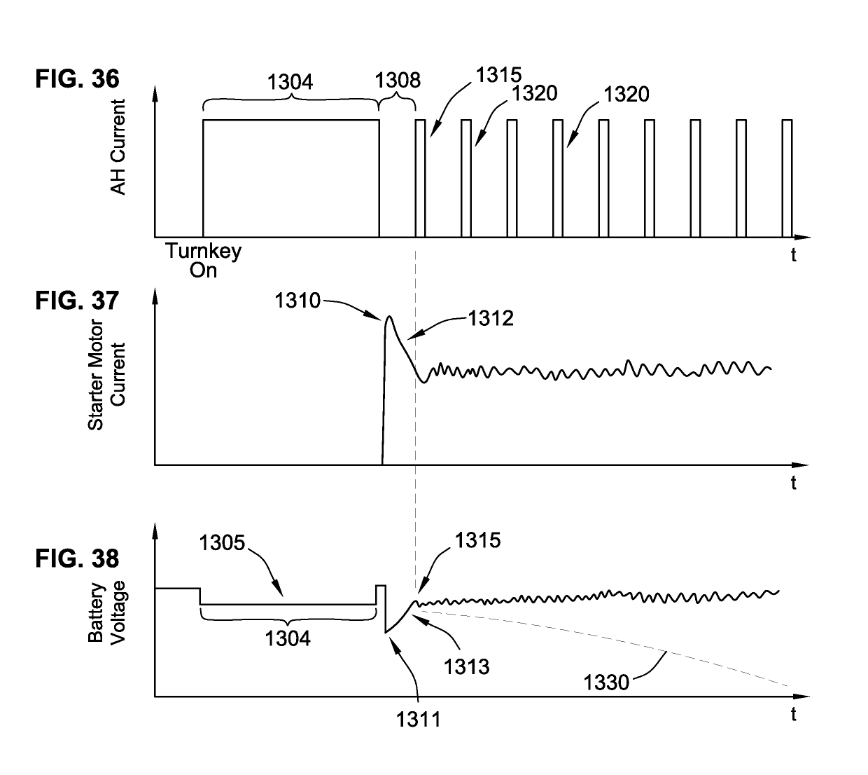

A second control strategy 1300 is illustrated in FIG. 35. This control strategy is similar to control strategy 1200 discussed above. However, this second control strategy 1300 monitors the voltage of the battery to determine when to reactivate the air heater. FIG. 36 illustrates current supplied to the air heater over time similar to FIG. 32. FIG. 37 illustrates current supplied to the starter motor over time, similar to FIG. 33. FIG. 38 illustrates the battery voltage over time.

The second control strategy begins with a first step 1302 of activating the air heater to preheat the heating element of the air heater for a predetermined amount of time 1304. The battery voltage will drop illustrated at section 1305 of FIG. 38. At this time, the starter motor is inactive and has not been activated and no current is supplied to the starter motor.

After the predetermined amount of time 1304 has elapsed, the second step 1306 includes stopping supplying power to the air heater for a second amount of time 1308 and the starter motor will be activated resulting in a current spike, illustrated at point 1310. While the starter motor experiences a current spike 1310, the battery voltage experiences a significant voltage drop, illustrated by negative voltage spike 1311. After the initial current spike at point 1310 and voltage drop at point 1311, the current draw by the starter motor will drop as illustrated by portion 1312 of FIG. 37 and the voltage will rise as illustrated by portion 1313 of FIG. 38.

The control strategy includes monitoring the battery voltage, as illustrated in step 1317. After the voltage of the battery is raised to an acceptable or predetermined level, such as point 1315, the air heater can be restarted to heat the heating element of the air heater while the starter motor continues to crank the motor, step 1316. Again, the heating element will typically be supplied current at a less than full power. Again, PWM will typically be used such that short bursts of full current will be supplied to the air heater such that the average power supplied to the air heater is approximately between about 10% and 50% of full power and more preferably between about 20% and 40% full power while the starter motor continues to crank the engine. However, PWM need not be used. FIG. 36 illustrates current spikes 1320 that correspond to the PWM supply of current. Again, other embodiments could utilize other methods to supply less than full power to the air heater heating element.

Further, while cranking of the engine, the voltage of the battery could continue to be monitored such that if the battery voltage were ever to drop below the predetermined voltage value (or a different predetermined value) the air heater would again be shut off to put all available power to the starter motor.

Typically, in both control strategies outlined above, the air heater will not be reactivated (steps 1216, 1316) until after the starter motor has cranked past the first top dead center.

FIG. 38 includes a dashed line 1330 that illustrates an empty battery situation. Here, the battery voltage would decrease after a few seconds. If such a voltage state was sensed, the air heater would also be shut off.

A further control strategy includes monitoring the supply voltage supplied to the heating system and adapting the pulse-width-modulation (PWM) duty cycle of the air intake heater based on the supply voltage. When the instantaneously supply voltage is higher, the PWM duty cycle is increased. When the supply voltage is lower, the PWM duty cycle is decreased. It is also possible to turn on the heater every time (for short periods of time) when the voltage rises due to less load on the starter motor. By doing so, a nearly constant current draw on the battery could he maintained.

To perform these control strategies, a controller of the air heater system would control the supply of current or power to the heating element accordingly.

The prior preheating control strategies help to reduce the amount of preheating time. By reducing the preheating time, these strategies provide the benefit of a smaller portion of the heat generated by the heating element is wasted during the preheating period, i.e. the intake manifold cover remains cold. Only the small portion of the intake manifold cover proximate the heating element is warmed.

These additional control strategies could also be employed to potentially reduce the size of the heating ribbon because less thermal accumulation (energy E) may be necessary to heat the intake air during engine start.

That energy is calculated as E=m*Q*ΔT, where Q is specific heat of heating ribbon and is in a range of 450 J/(kg*K) As it is desired to heat the heating ribbon to the same high temperature (ΔT=˜900K), the viable way to reduce the needed energy is to reduce a mass m of heating element. In reducing the mass of the heating ribbon, the heating ribbon should be thinner and shorter at the same time in order to have the same resistance after change in cross-sectional dimension.

For example, when the cross-section of the heating ribbon is reduced to two-thirds of the original cross-section while maintaining the same length of the heating ribbon, the following detrimental effects would occur. First, the resistance of the heating ribbon would increase to 1.5 times the original resistance. The power of the heating ribbon would decrease to two thirds of the original power. The mass of the heating ribbon (which is correlated to the thermal accumulation) would decrease to two-thirds of the original mass.

As a result, the preheating time would remain the same because it follows the quotient between mass and power.

To reduce preheating lime, the heating element length must also be decreased. For instance, if the heating element length was reduced twenty percent (20%) in the above analysis with the one-third reduction in cross section the following results. First, the resistance of the heating ribbon will further decrease to 0.8 (80%). Taking this 0.8*3/2 (due to the change in cross-section) results in an increase of resistance of 1.2 of the original resistance. The power of the heating ribbon would further increase to 1.25 the original power due to the reduction in length. Taking this increase in power for change in length of 1.25*2/3 (due to change in power for reduction in cross-section) you will end up with 0.83 of the original power. The mass of the heating ribbon would further decrease to 0.8*2/3 resulting in 0.53 the original mass.

Because the preheating time follows the proportion between mass and power, the change in preheating time would be 0.53/0.83 resulting in a preheating time of 0.64 of the original preheating time.

The following examples also illustrate the benefits of the improved control strategies outlined above relating to heating while engine cranking during engine start. The following example will assume ideal conditions (where no heat is lost).

The needed constant power to instantly heat the air passing the air heater during engine start cranking of the engine is in the range of between 280 and 425 W. It is noted that a 6.7 liter engine has been considered. However, decreasing engine capacity would proportionally decrease needed power. The cranking speed is estimated to be between 100 rpm and 150 rpm. However, lowering the cranking speed would proportionally decrease the needed power. Additionally, a 40 Kelvin air temperature increase has been used in calculations. However, reducing the air temperature increase would proportionally decrease the needed power.

If it is assumed that fifty percent (50%) of the heating energy is lost to waste heat for heating the intake manifold before the heated air reaches the combustion chamber, the needed power is in a range of 560 to 850 W.

That power is low enough to be additionally taken from the battery during cranking (i.e. after the initial spike at initiation of the engine start). This is particularly true because there will be some heat accumulation in the heating ribbon due to the period of preheat prior to beginning engine cranking during engine start.

The following examples illustrate how the air heater power needed during cranking during engine start was calculated. A 1-cylinder 4-stroke engine intakes air 1× per 2 revolutions. A 2-cylinder 4-stroke engine intakes air1× per 1 revolution. A 6 cylinder 4-stroke engine intakes air 3× per 1 revolution. If we consider a 6 cylinder, 6.7 liter engine, it intakes 1/6*3*6.7 liter=3.35 liter of air per revolution.

Two cranking speeds, 100 rpm (1.67 rev/sec) and 150 rpm (2.50 rev/sec) will be considered. For a cranking speed of 100 rpm, the volume of intake air per second would be 1.67 rev/sec*3.35 liters/rev for a rate of 5.6 liters of intake air per second. For a cranking speed of 150 rpm, the volume of intake air per second would be 2.50 rev/sec*3.35 liters/rev=8.4 liters of intake air per second.

The mass of the intake air can be calculated from the following equation: m=V*p, where p is specific density of air (1.252 kg/m3) at the anticipated temperatures. For the 100 rpm example, 5.6 liters of intake air per second=0.007 kg/sec of intake air. For the 150 rpm example, 8.4 liters of intake air per second=0.0105 kg/sec of intake air.

As noted above, the equation to determine the amount of required energy is E=m*Q*ΔT, where ΔT=40 Kelvin (heating from −20° C. to +20° C.) a is the specific heat of air (1009 J/[kg*K]). For the 100 rpm example, the needed energy each second is 283 Joules. Because Joules per second is Watts, the needed power is 283 W. For the 150 rpm example, the needed energy each second is 424 Joules. Because Joules per second is Watts, the needed power is 424 W.

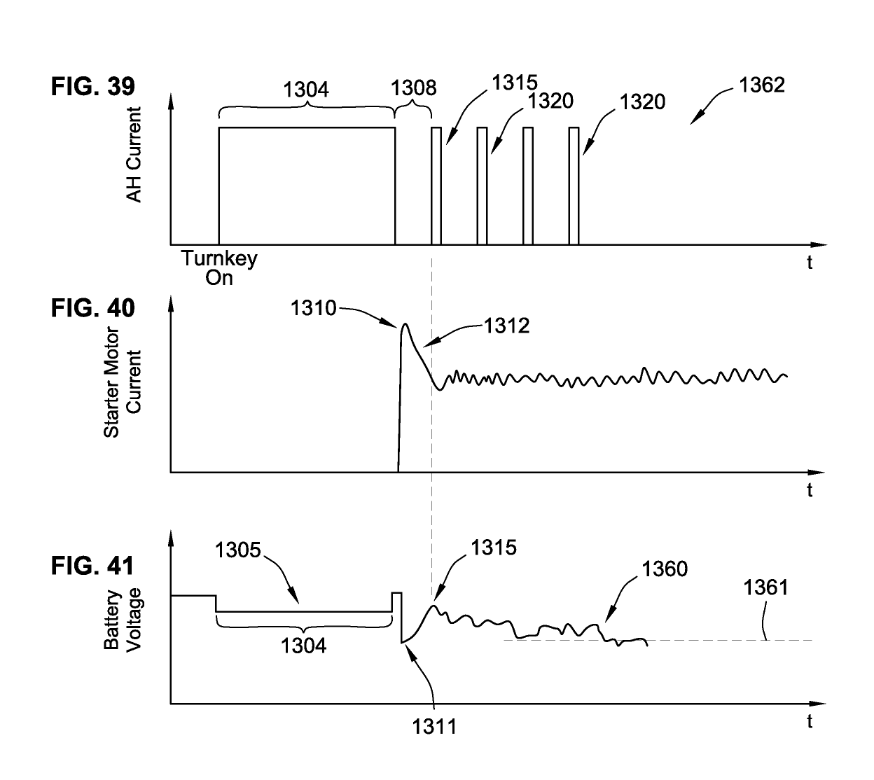

FIGS. 39-41 illustrate, in graphic form, a further feature. FIG. 41 illustrates a situation where the battery voltage drops below a predetermined threshold (line 1361) illustrated at point 1360 while cranking the engine using the starter motor and while the air heater is active. In this situation, when the battery voltage drops below this predetermined thresh 1360, the air heater is turned off but cranking of the starter motor continues to attempt to start the motor, as illustrated by FIG. 40. This is illustrated by region 1362 of FIG. 39. By shutting off the air heater, sufficient energy is provided for continuing to energize the starter motor.

FIG. 40 is substantially the same as FIG. 37 but included to facilitate understanding. This analysis of monitoring the battery voltage while the air heater and the starter motor are both active can be built into the prior discussed control strategy and control systems.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An air intake heater comprising:
a heating element including a plurality of longitudinally extending sections, each longitudinally extending section having an inlet end and an outlet end and defining a guide face extending between the inlet end and the outlet end;
wherein the inlet ends of the plurality of longitudinally extending sections generally define an inlet face and the outlet ends of the plurality of longitudinally extending sections generally defines an outlet face; and
wherein at least the outlet end of the guide face of each of the longitudinally extending sections extends at a non-perpendicular angle to the inlet and outlet faces.

2. The air intake heater of claim 1, wherein the heating element further includes a plurality of curved connection portions, each connection portion connecting an adjacent pair of the longitudinally extending sections.

3. The air intake heater of claim 2, wherein each curved connection portion defines a trough bottom extending between a top end of the connection portion and a bottom end of the connection portion, the trough bottom being non-perpendicularly angled relative to the inlet and outlet faces.

4. The air intake heater of claim 3, further comprising a first insulator and a second insulator, the heating element mounted between the first and second insulators with the longitudinally extending sections extending between first and second insulators with each curved connection portion supported by or inserted into one of the first or second insulators.

5. The air intake heater of claim 4, wherein first and second insulators define generally rectangular receiving cavities for receiving the curved connection portions, the receiving cavities being rotated at an angle relative to the inlet and outlet faces such that four of the sides of the rectangular cavities extend at non-parallel and non-perpendicular angles relative to the inlet and outlet faces.

6. The air intake heater of claim 5, wherein the rectangular receiving cavities include top and bottom sides, the top side adjacent the inlet ends of the longitudinally extending sections and the bottom side adjacent the outlet ends of the longitudinally extending sections, the top sides being parallel to one another but offset such that they are not aligned and the bottom sides being parallel to one another but offset such that they are not aligned.

7. The air intake heater of claim 2, wherein the longitudinally extending sections and connection portions are formed from a single continuous ribbon of material.

8. The air intake heater of claim 2, wherein each curved connection portion defines a trough bottom extending between a top end of the connection portion and a bottom end of the connection portion, the trough bottom extending perpendicularly relative to the inlet and outlet faces.

9. The air intake heater of claim 8, wherein the curved connection portions include a pair of twisted sections that transition into the corresponding longitudinally extending sections.

10. The air intake heater of claim 8, further comprising a first insulator and a second insulator, the heating element mounted between the first and second insulators with the longitudinally extending sections extending between first and second insulators with each curved connection portion supported by or received into one of the first or second insulators;
the first and second insulators define generally rectangular receiving cavities for receiving the curved connection portions, the receiving cavities being oriented relative to the inlet and outlet faces such that two of the sides of the rectangular cavities extend perpendicular to the inlet and outlet faces and two of the sides of the rectangular cavities extend parallel to the inlet and outlet faces.

11. (canceled)

12. The air intake heater of claim 1,
wherein the guide face of each of the longitudinally extending sections is curved between the inlet and outlet ends.

13-15. (canceled)

16. The air intake heater of claim 8, further comprising a first insulator and a second insulator, the heating element mounted between the first and second insulators with the longitudinally extending sections extending between first and second insulators with each curved connection portion supported by one of the first or second insulators;
the first and second insulators define generally rectangular receiving cavities for receiving the curved connection portions, the receiving cavities being oriented relative to the inlet and outlet faces that two of the sides of the rectangular cavities extend perpendicular to the inlet and outlet faces and two of the sides of the rectangular cavities extend parallel to the inlet and outlet faces.

17. A method of forming an intake heater comprising:
bending a ribbon of heating element material into a plurality of longitudinally extending sections connected by curved connection portions, the longitudinally extending sections having an inlet end and an outlet end and a guide face extending between the inlet and outlet faces, the inlet ends of the plurality of longitudinally extending sections generally define an inlet face and the outlet ends of the plurality of longitudinally extending sections generally defines an outlet face;
deforming the bent ribbon of heating element material such that the guide face of each of the longitudinally extending sections extends at a non-perpendicular angle to the inlet and outlet faces, at least at the outlet end of the guide face.

18. The method of claim 17, wherein each curved connection portion defines a trough bottom extending between a top end of the connection portion and a bottom end of the connection portion, the step of deforming includes bending the ribbon of heating material such that the trough bottom of each curved connection portion is non-perpendicularly angled relative to the inlet and outlet faces.

19. The method of claim 18, further comprising mounting the ribbon of heating material between a pair of insulators with the curved connection portions positioned within rectangular cavities, the rectangular cavities being rotated at an angle relative to the inlet and outlet faces such that four of the sides of the rectangular cavities extend at non-parallel and non-perpendicular angles relative to the inlet and outlet faces.

20. The method of claim 17, wherein each curved connection portion defines a trough bottom extending between a top end of the connection portion and a bottom end of the connection portion, the step of deforming includes bending the ribbon of heating material such that the trough bottom of each curved connection portion remains perpendicular relative to the inlet and outlet faces.

21-80. (canceled)

81. The method of claim 17, wherein the guide face of each of the longitudinally extending sections is curved between the inlet and outlet ends.

82. The air intake heater of claim 1, wherein the inlet end of the guide face of each of the longitudinally extending sections extends at a non-perpendicular angle to the inlet face.
